(19) United States
(12) Patent Application Publication
(10) Pub. No.: US 2024/0342957 A1
(43) Pub. Date: Oct. 17, 2024

(54) SAW SYSTEMS AND METHODS OF CUTTING A WORKPIECE

(71) Applicant: CB INTERESTS INC., Woodstock (CA)

(72) Inventor: Christof Jasinski, Woodstock (CA)

(21) Appl. No.: 18/580,264

(22) PCT Filed: Jul. 20, 2022
(86) PCT No.: PCT/CA2022/051128

§ 371 Date: Jan. 18, 2024

Related U.S. Application Data
(60) Provisional application No. 63/223,820, filed on Jul. 20, 2021.
(60) Provisional application No. 63/319,994, filed on Mar. 15, 2022.

(51) Int. Cl. B28D 7/04; B28D 1/04; B28D 7/02

(52) U.S. Cl. CPC B28D 7/04; B28D 1/044; B28D 7/02

(57) ABSTRACT

Systems, devices, and methods for cutting a workpiece are described herein. The systems include a clamp having an elongate body having a top surface, a bottom surface, a first end and a second end, the elongate body being positioned above the workpiece and below a motor of the saw; a first connector configured to secure the first end of the elongate body to the base at a first side of the base; and a second connector configured to secure the second end of the elongate body to the base at a second side of the base. The first connector and the second connector provide for the clamp to move between a raised position where the elongate body is coupled to the base and disengaged from a top surface of the workpiece and a lowered position where the elongate body is coupled to the base and presses down on the top surface of the workpiece and secures the workpiece against the upper surface of the base when the workpiece is positioned between the first connector and the second connector.

### TECHNICAL FIELD

The embodiments disclosed herein relate to saw systems and methods of cutting workpieces, and more specifically, to tile saw systems and methods of cutting ceramic tiles.

### BACKGROUND

The development and use of stone tiles, cementitious pavers and porcelain tiles for outdoor applications (e.g. used for the replacement of natural stone and cementitious pavers) is quickly increasing given their low maintenance, durability and weather resistance. Modern porcelain tiles are often thicker, denser and have ever increasing large formats (e.g., 32 inches or more in length along one side).

When installing large stone tiles, cementitious pavers and porcelain tiles in outdoor spaces, the installer is often required to make precise and long cuts. Cutting these tiles is much more difficult than cutting plywood and/or composite-based panels because of their density and hardness. Installers often refer to large format tiles as “slabs”. Further, cutting stone slabs, cementitious pavers and porcelain tiles during a site installation requires the use of portable machines that can be easily transported to the worksite.

There are many different forms of portable tile saws in the market currently, but these portable saws typically lack the stiffness and precision necessary to provide consistently straight cuts in thicker, denser and larger format slabs and tiles.

In a tile manufacturing factory, sawing machines become large and heavy. In these factories, sawing heads are strategically placed in the moving production line. However, it is common to have off-line saws that are used for special sizing jobs, small run jobs, rework, etc. These offline industrial saws are conceptually similar in design to the contractor saws available in the market, but they are heavier, and have various degrees of automation.

Historically, with tile, stone and slab cutting, the heavy item to be cut is placed on a table and against a fence and either the blade is pushed through the workpiece (e.g. towards the fence) or the workpiece (resting on top of a movable table/fence, is pushed through a stationary sawing head. In both cases, the part being cut is heavy and (historically) it is left unclamped during the cutting process. This is acceptable when tolerances are wide and cutting errors can be compensated by installation processes. However, modern installation systems often require cut tolerances with accuracy of 0.04″ or less. Making long cuts to these tolerance levels is impractical when the part being cut is free to move because of cutting forces or if the machine doing the cutting is insufficiently rigid and goes off the desired track as a result of these same cutting forces.

Many currently available portable saws are designed for cutting panels (e.g., wood or light composites) and are also designed so that the panel being cut is free to move during cutting. With these saws, the operator is responsible for maintaining that the panel being cut is in a proper position relative to the blade to achieve cutting accuracy. When the cutting is relatively easy (e.g. wood or light composites) this approach works well and has been honed by tradesmen and power tool manufacturers for many years. However, this approach is undesirable for cutting heavy and large format stone tiles, cementitious pavers or porcelain tiles. Cutting an unclamped workpiece with these materials results in a lack of precision, lack of repeatability during production and safety concerns.

Track saws are designed to make long straight cuts on panels. To do so, track saws have a track that is clamped directly to the panel and include a saw that drops onto a guide track from above. Track saws are designed for 90-degree cuts and are impractical for making miter cuts along the length of a tough workpiece. Further cutting tough materials like stone, cementitious pavers and heavy porcelain tiles requires wet cutting and track saws are not designed for wet cutting as they do not have built in coolant delivery or control systems. Because the saw is only guided but not secured on to the track, the track saw system relies on pressure from a human operator to counteracting cutting forces. This is very difficult to do in tough materials. Conventional track saws are not appreciated by many tradesmen. They are considered awkward and light duty. Conventional track saws are do not provide the precision and repeatability that are necessary when cutting stone, cementitious pavers and heavy porcelain tiles.

FIGS. 1A-1D show an example of a prior art track saw. In this case, the track saw includes a skill saw resting on a carriage that is configured to slide along a saw guide. The saw guide is directly clamped to the workpiece (e.g. plywood) so that a user can make straight cuts. Unfortunately, as noted above, conventional track saws are not suited for cutting stone, cementitious pavers and heavy porcelain tiles because they lack many of the features required of the application.

FIGS. 2A-2C show an example of a prior art moving table saw. Moving table saws remain a popular type of saw, however, as tile sizes and toughness increase, moving table saws are unfavorable because of their length and lack of rigidity. Further, moving table saws are more suited to a factory environment as they are often bulky and heavy. Moving table saws are therefore not suited for contractors that are cutting stone, cementitious pavers and heavy porcelain tiles that are looking for a portable solution, particularly when quality or output demand is high.

FIGS. 3A-3H are examples of a prior art gantry saws. In the example gantry saws shown, a saw head is hung from a guide that is vertically spaced above the workpiece to be cut. Gantry saws are typically not suited for cutting heavy, large format tiles because the workpiece is not clamped to the base and can move easily when confronted with high cutting forces and vibration. Further, in the examples shown, the cutting line of the workpiece is vertically spaced far apart from the guide system, considerably magnifying any deflection of the machine components when faced with the resistance of cutting a hard tile. The result is instability that often results in the workpiece moving during cutting, crooked cuts and scrap parts.

Gantry saws are preferred in both portable installation and modern factory environments. Given that the blade moves through the slab, this machine concept is shorter than the moving table concept. By being shorter, this machine concept has the potential for being more rigid than the moving table system. However, because the gantry is large, stiffness of the gantry is difficult to achieve without serious investment and added weight. Accordingly, it is difficult to balance performance, weight and cost for portable machines and for small stationary machines.

For both gantry and moving table saws, the industry favors climb-cutting because cutting forces push the tile downwardly towards the table. For successfully cutting stone, cementitious pavers and heavy porcelain tiles, the blade must be rigidly and consistently fed along the cutting path, ample water must be delivered, and neither the tile nor the blade can move from the cutting path or vibrate during the cutting process. Existing technologies does not actively secure the tile during cutting and this necessitates climb-cutting towards a fence. This puts limits on process, machine design, and performance of the existing technologies primarily in the contractor machine space.

There is a need for a saw system capable of safely, consistently and repeatedly cutting the dense, tough, large format tiles that are currently being manufactured by industry. Many installers desire saws that can quickly do miter cuts and bevels consistently and reliably on these tough to cut tiles. The demand for higher production rates and cutting accuracy is increasing as new tile installation systems are developed. Installers look for operational convenience, precision, stiffness, portability and large cutting capacity in the saw they choose. There is a significant gap in the needs of installers and the current state of the art in portable large format tile/slab cutting machines. Further, there is a need for a capital cost effective sawing machine for offline production cutting. Current technologies have limitations in achieving these needs. An altered approach is required.

### SUMMARY

In accordance with a broad aspect, a clamp for securing a workpiece against an upper surface of a base for a saw to cut the workpiece while travelling in a direction parallel to a longitudinal axis of the clamp is described herein. The clamp includes an elongate body having a top surface, a bottom surface, a first end and a second end, the elongate body being positioned above the workpiece and below a motor of the saw. The clamp also includes a first connector configured to secure the first end of the elongate body to the base at a first side of the base; and a second connector configured to secure the second end of the elongate body to the base at a second side of the base. The first connector and the second connector provide for the clamp to move between a raised position where the elongate body is coupled to the base and disengaged from a top surface of the workpiece and a lowered position where the elongate body is coupled to the base and presses down on the top surface of the workpiece and secures the workpiece against the upper surface of the base when the workpiece is positioned between the first connector and the second connector.

In at least one embodiment, the elongate body maintains a position above the workpiece and below the motor of the saw as the clamp moves between the raised and lowered positions.

In at least one embodiment, the first connector and the second connector provide for the elongate body of the clamp to remain parallel with the top surface of the base as the clamp moves between the raised position and the lowered position.

In at least one embodiment, the first connector and the second connector each include a linkage member that is pivotally coupled to the base and pivotally coupled to the elongate body of the clamp.

In at least one embodiment, the first connector is a hinge positioned at the first end of the elongate body and the second connector includes an actuator positioned at the second end of the elongate body and is configured to extend upwardly from the base to move the clamp between the raised position and the lowered position.

In at least one embodiment, the clamp includes two actuators, one actuator being positioned at each of the first end and the second end of the elongate body.

In at least one embodiment, the clamp also includes an actuator having a first end coupled to the elongate body and a second end coupled to the base, the actuator being configured to move the elongate body between the raised position and the lowered position.

In at least one embodiment, the clamp includes a conformity mat covering at least a portion of the bottom surface of the elongate body.

In at least one embodiment, the workpiece has a first edge positioned adjacent to the first side of the base and a second edge adjacent to the second side of the base and the elongate body presses down on the top surface of the workpiece and secures the workpiece against the upper surface of the base from the first edge of the workpiece to the second edge of the workpiece.

In at least one embodiment, the clamp includes a guide configured to direct motion of a carriage carrying a saw for the saw to cut a workpiece while travelling in a direction parallel to a longitudinal axis of the clamp.

In at least one embodiment, the guide is a rail forming the top surface of the elongate body, the rail being shaped to slidingly couple with the carriage to direct the motion of the carriage and the saw.

In at least one embodiment, the guide is a rail coupled to the elongate body, the rail being shaped to slidingly couple with the carriage to direct the motion of the carriage and the saw.

In at least one embodiment, the elongate body presses down across the top surface of the workpiece and secures the workpiece against the upper surface of the base from a first edge of the workpiece to a second edge of the workpiece.

In accordance with a broad aspect, a saw system is described herein. The saw system includes a base having an upper surface to support a workpiece thereon, the upper surface of the base being sloped relative to the ground, a clamp described herein; and a carriage coupled to the clamp and configured to carry a saw to cut the workpiece.

In at least one embodiment, the base includes a drainage mat, a table having the drainage mat positioned on top of the table and the workpiece positioned on top of the drainage mat and a water trough positioned adjacent to the workpiece to collect water travelling on a top surface of the workpiece and/or within the drainage mat below the workpiece.

In at least one embodiment, the water trough is positioned adjacent to a lower end of the workpiece to collect water travelling on the top surface of the workpiece and/or within the drainage mat.

In at least one embodiment, the water trough includes one or more openings to receive water from the drainage mat.

In at least one embodiment, the system also includes a manual actuator configured to move the clamp between the raised and lowered positions and a powered actuator configured to drive the carriage carrying the saw from a home position to a stop position along the longitudinal axis of the clamp for the saw to cut the workpiece.

In at least one embodiment, the manual actuator is configured to provide for the carriage to disengage the powered actuator when the clamp is at the raised position and the carriage can be moved manually by a user to return the carriage to the home position.

In at least one embodiment, the powered actuator comprises a carriage-mounted drive motor with a drum and a wire having a variable length, and the clamp comprises a spring tensioner that disengages the carriage from the powered actuator when the clamp is at the raised position.

In at least one embodiment, the system includes a cart for transporting the saw system, the cart having a tiltable frame that provides for the car to move between a working position and a travel position, the cart having a smaller width when in the travel position than when in the working position.

In at least one embodiment, the system includes a controller configured to: receive a first signal confirming that the carriage is at a home position; in response to receiving the first signal and receiving a user input, activate a water pump, a blade drive of the saw and the powered actuator of the carriage to initiate cutting the workpiece; and receive a second signal confirming that the carriage is at a stop position; and in response to receiving the second signal, deactivate the water pump, the blade drive of the saw and the powered actuator of the carriage.

In accordance with a broad aspect, a method of cutting a workpiece with a saw of a saw system is described herein. The method includes positioning the workpiece on an upper surface of a base of the saw system between a first connector and a second connector of a clamp of the saw system, the upper surface of the base being sloped relative to the ground; positioning the workpiece on the base so a desired cut line of the workpiece is aligned with a blade of the saw; moving the clamp to a lowered position where an elongated body of the clamp presses down on the top surface of the workpiece and secures the workpiece against the upper surface of the base; and while the clamp remains in the lowered position, directing a carriage carrying the saw in a direction parallel to a cut line and parallel to a longitudinal axis of the clamp to cut the workpiece along the cut line.

### BRIEF DESCRIPTION OF THE DRAWINGS

The drawings included herewith are for illustrating various examples of articles, methods, and apparatuses of the present specification. In the drawings:

FIG. 1A is an exploded side view of the components of a prior art track saw including a skill saw, a carriage, a track and two clamps.

FIG. 1B is an end view of the prior art track saw of FIG. 1A.

FIG. 1C is a top view of the prior art track saw of FIG. 1A.

FIG. 1D is a side views of the prior art track saw of FIG. 1A.

FIGS. 2A is an end view of a prior art moving table saw.

FIG. 2B is a top view of the prior art moving table saw of FIG. 2A.

FIG. 2C is a side view of the prior art moving table saw of FIG. 2A.

FIG. 3A is an end view of a prior art portable gantry saw.

FIG. 3B is a top view of the prior art portable gantry saw of FIG. 3A.

FIG. 3C is a side view of the prior art portable gantry saw of FIG. 3A.

FIG. 3D is an end view of the prior art portable gantry saw of FIG. 3A showing the saw tilted 45 degrees.

FIG. 3E is a top view of a prior art stationary gantry saw.

FIG. 3F is an end view of the prior art stationary gantry saw of FIG. 3E.

FIG. 3G is another top view of a prior art stationary gantry saw of FIG. 3E showing its ability to make straight cuts.

FIG. 3H is another top view of a prior art stationary gantry saw of FIG. 3E showing its ability to make angled cuts.

FIG. 4A is an end view of a saw system according to at least one embodiment described herein.

FIG. 4B is a top view of the saw system of FIG. 4A.

FIG. 4C is a side view of the saw system of FIG. 4A.

FIG. 4D is a side view of the saw system of FIG. 4A showing a clamp of the saw system in a raised position.

FIG. 4E is a side view of another saw system according to at least one embodiment described herein showing a clamp of the saw system in a lowered position.

FIG. 4F is a top view of the saw system of FIG. 4E showing the clamp of the saw system in a raised position.

FIG. 4G is a side view of another saw system according to at least one embodiment described herein showing two clamps on either side of a cut line, one being in an open position and one being in a closed position.

FIG. 4H is another side view of the system of FIG. 4G with the clamp in the lowered position.

FIG. 4I is an end view of the system of FIG. 4G with the clamp in the lowered position.

FIG. 4J is another side view of the system of FIG. 4G with the clamp in the raised position.

FIG. 4K is another side view of the system of FIG. 4G with the clamp in the raised position.

FIG. 4L is an end view of a saw system according to at least one embodiment described herein.

FIG. 4M is a top view of the saw system of FIG. 4L.

FIG. 4N is a side view of the saw system of FIG. 4L.

FIG. 5A is a side view of a clamp, carriage and saw of the saw system of FIGS. 4G-I showing the clamp at a lowered position, according to at least one embodiment described herein.

FIG. 5B is a side view of the saw system of the clamp, carriage and saw of FIG. 5A, showing the clamp at a raised position.

FIG. 5C is a side view of a saw system according to at least one embodiment described herein showing a clamp of the saw system in a lowered position.

FIG. 5D is a top view of the saw system of FIG. 5C showing the clamp of the saw system in a raised position.

FIG. 5E is a side view of a saw system according to at least one embodiment described herein showing a clamp of the saw system in a lowered position.

FIG. 5F is a top view of the saw system of FIG. 5E showing the clamp of the saw system in a raised position.

FIG. 5G is a side view of a saw system according to at least one embodiment described herein showing two actuators and a clamp of the saw system in a lowered position.

FIG. 5H is a side view of a saw system according to at least one embodiment described herein showing two actuators and a clamp of the saw system in a raised position.

FIG. 5I is a magnified side view of a saw system according to at least one embodiment described herein showing a manual actuator and a clamp at a lowered position.

FIG. 5J is a magnified end view of the saw system of FIG. 5I showing the manual actuator and the clamp at a raised position.

FIG. 5K is two end views of a saw system according to at least one embodiment described herein showing a saw of the saw system in a neutral position and in a pivoted position, respectively, and the clamp at a lowered position.

FIG. 5L is two end views of a saw system according to at least one embodiment described herein showing a saw of the saw system in a neutral position and in a pivoted position, respectively, and the clamp at a raised position.

FIG. 5M is two end views of a saw system according to at least one embodiment described herein showing a saw of the saw system in a neutral position and in a pivoted position, respectively, and the clamp at a lowered position.

FIG. 5N is two end views of a saw system according to at least one embodiment described herein showing a saw of the saw system in a neutral position and in a pivoted position, respectively, and the clamp at a raised position.

FIG. 5O is a top view of a saw system according to at least one embodiment described herein showing a clamp having a slot.

FIG. 5P is an end view of the saw system of FIG. 5O.

FIG. 5Q is a magnified side view of a saw system according to at least one embodiment described herein showing a linkage connector and a water trough.

FIG. 5R is an end view of the saw system of FIG. 5Q.

FIG. 6A is a magnified side view of a saw system according to at least one embodiment described herein showing a saw carried by a carriage and a powered actuator mounted to the carriage.

FIG. 6B is an end view of the saw system of FIG. 6A.

FIG. 6C is a side view of the saw system of FIG. 6A showing the clamp at a raised position.

FIG. 6D is a side view of the saw system of FIG. 6A showing the clamp at a lowered position and the saw cutting the workpiece.

FIG. 7A is a side view of a saw system according to at least one embodiment described herein showing a water trough and a water tank of the system.

FIG. 7B is a top view of the saw system of FIG. 7A.

FIG. 7C is an end view of a first water trough of the saw system of FIG. 7A.

FIG. 7D is a top view of a saw of a saw system according to at least one embodiment described herein showing a proximity switch of the saw.

FIG. 7E is a top view of a saw system according to at least one embodiment described herein showing two pins for conveying a position to the proximity switch of the saw of FIG. 7D.

FIG. 7F is a top view of the saw system of FIG. 7E showing a saw being carried by the carriage.

FIG. 7G is a top view of a block for conveying a position to the proximity switch of the saw of FIG. 7D.

FIG. 7H is a top view of a saw system according to at least one embodiment described herein showing the block of FIG. 7G being positioned at an end of a workpiece of a first size.

FIG. 7I is a top view of a saw system according to at least one embodiment described herein showing the block of FIG. 7G being positioned at an end of a workpiece of a second size.

FIG. 7J is a magnified side view of a saw system according to at least one embodiment described herein showing a saw of the system at a first cutting depth.

FIG. 7K is a magnified side view of the saw system of FIG. 7J showing a saw of the system at a second cutting depth.

FIG. 7L is a side view of a cart carrying a saw system according to at least one embodiment described herein.

FIG. 7M is an end view of the cart of FIG. 7L in a working position carrying a saw system according to at least one embodiment described herein.

FIG. 7N is an end view of the cart of FIG. 7L in a travel position carrying a saw system according to at least one embodiment described herein.

FIG. 8A is a top view of a saw system according to at least one embodiment described herein having a workpiece in a first position.

FIG. 8B is a top view of the saw system of FIG. 8A having a workpiece in a second position.

FIG. 8C is a top view of the saw system of FIG. 8A having a workpiece in a third position.

FIG. 8D is a top view of the saw system of FIG. 8A having a workpiece in a fourth position.

FIG. 9A is a top view of a saw system according to at least one embodiment described herein showing a clamp of the saw system at a home position.

FIG. 9B is a top view of the saw system of FIG. 9A showing the clamp of the saw system at a cutting position.

FIG. 9C is a top view of the saw system of FIG. 9A showing the clamp of the saw system at a cutting position and a turn table of the saw system at a first rotated position.

FIG. 9D is a top view of the saw system of FIG. 9A showing a workpiece having angled cuts supported on the turn table.

FIG. 9E is a top view of the saw system of FIG. 9A showing two workpieces having vertical and horizontal cuts supported on the turn table.

FIG. 9F is a top view of the saw system of FIG. 9A showing two workpieces having vertical and horizontal cuts supported on the turn table.

FIG. 10A is a side view of a coping tile cut with a saw system according to at least one embodiment described herein.

FIG. 10B is a side view of the coping tile of FIG. 9A positioned on a coping bracket of a decking system.

FIG. 10C is a rear perspective view of the coping tile of FIG. 9A.

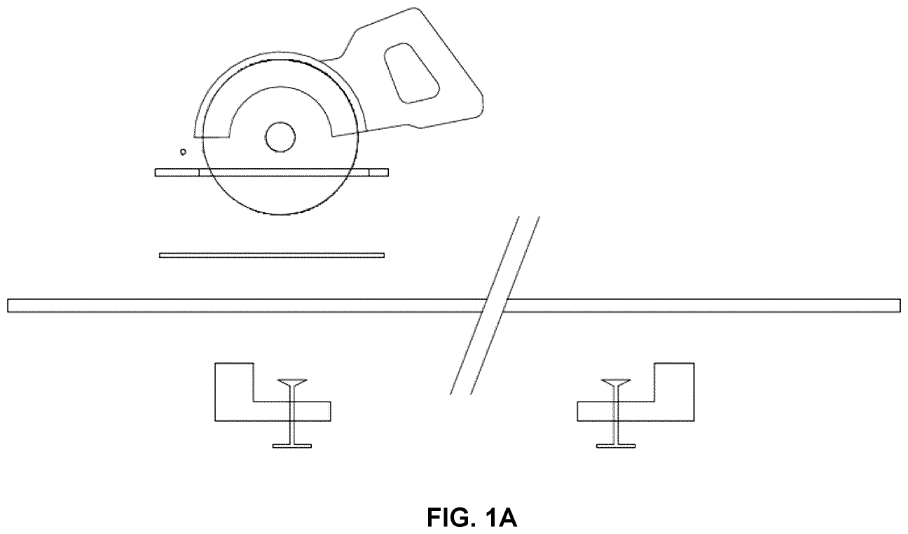

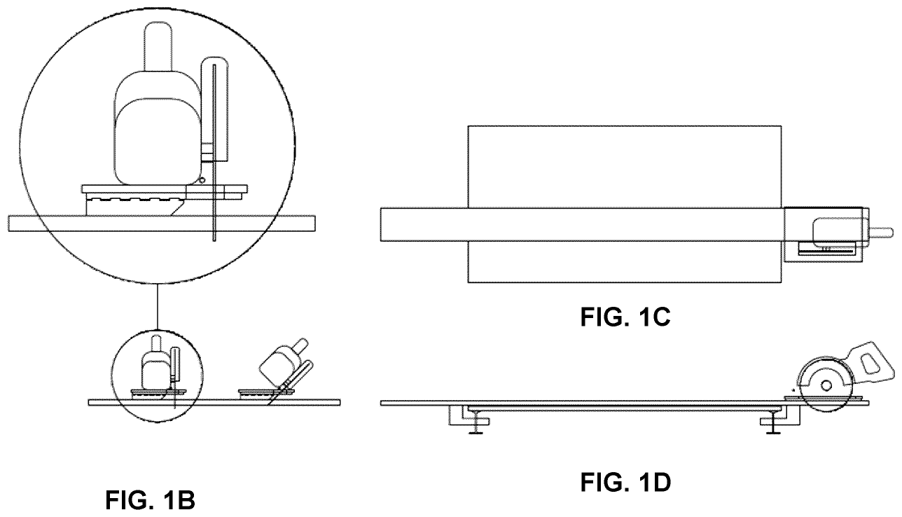

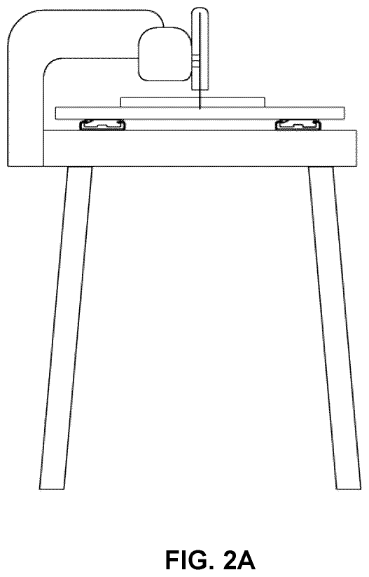

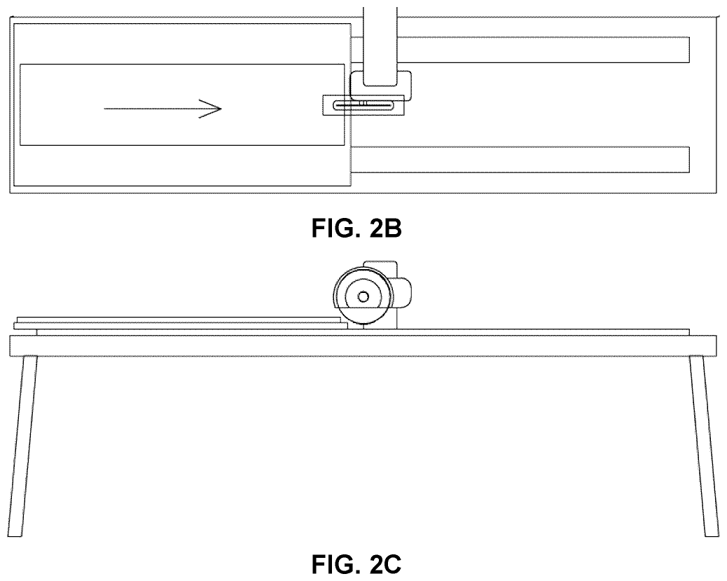

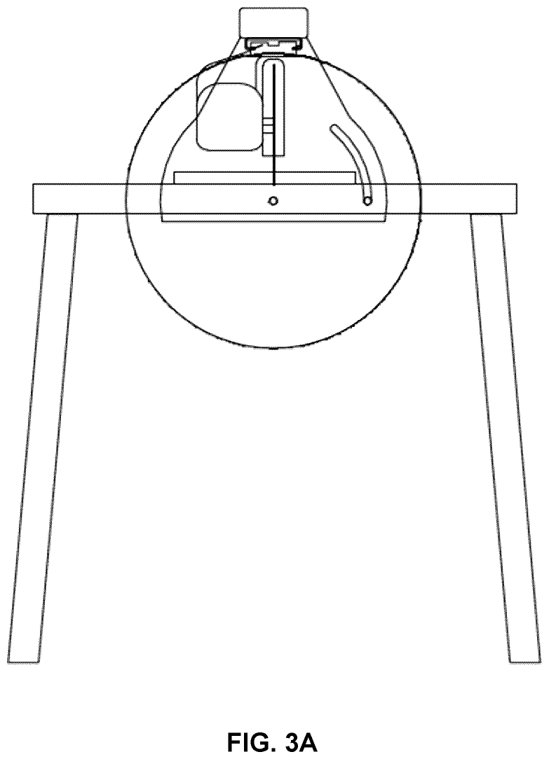

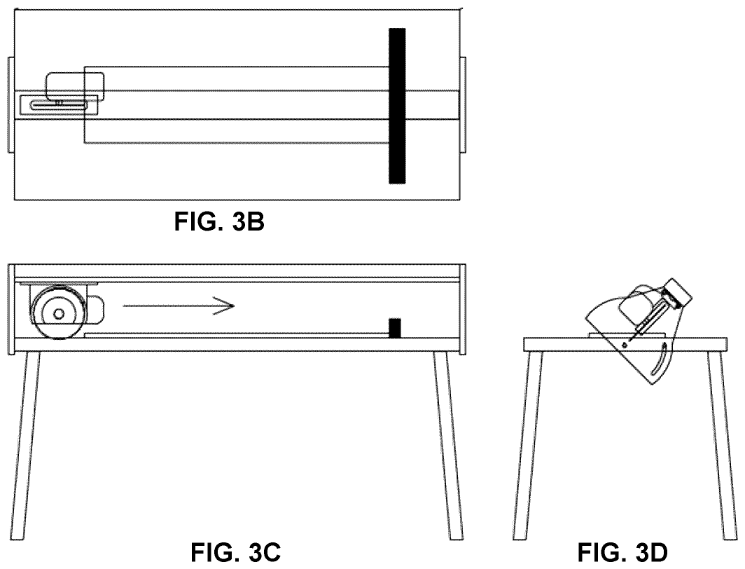

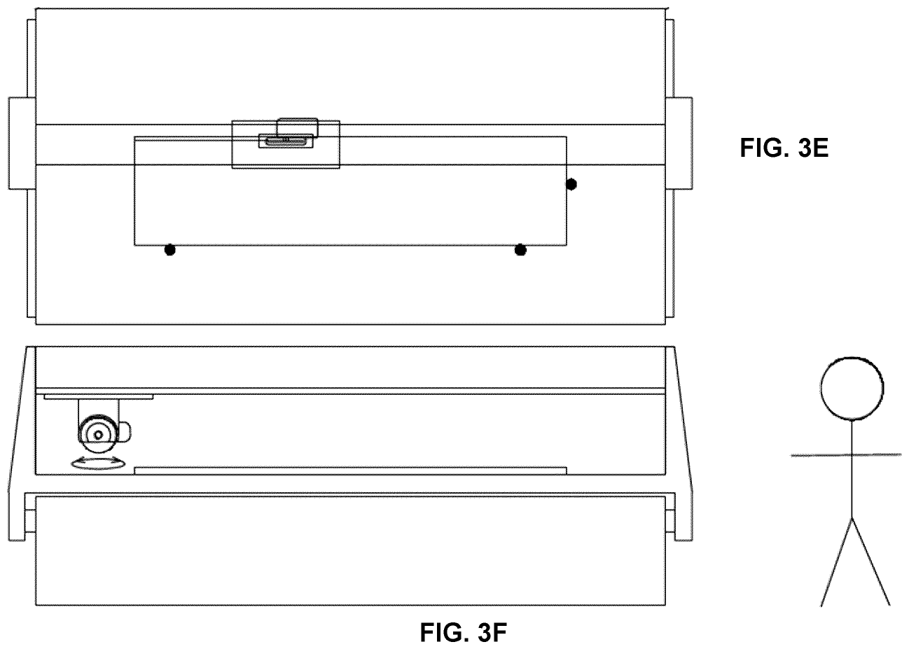

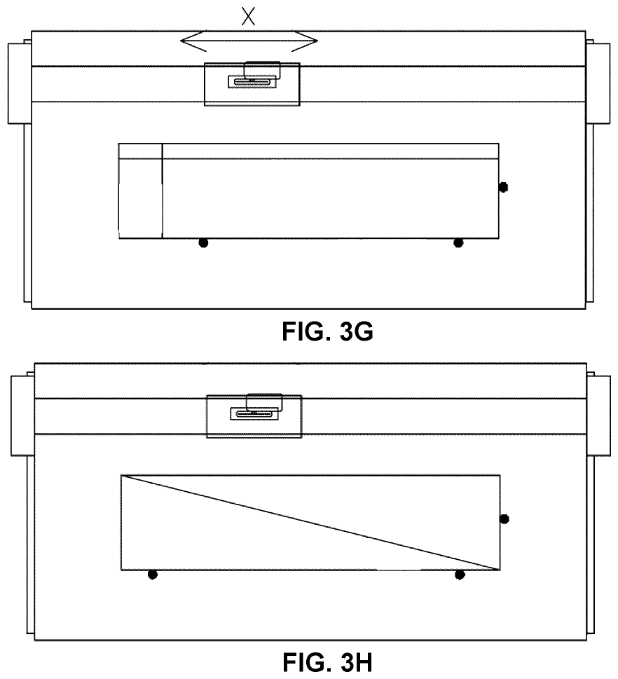

### DETAILED DESCRIPTION

Various systems, apparatus or processes will be described below to provide an example of one or more embodiments. No embodiment described below limits any claimed embodiment and any claimed embodiment may cover systems, processes or apparatus that differ from those described below. The claimed embodiments are not limited to systems, apparatus or processes having all of the features of any one system, apparatus or process described below or to features common to multiple or all of the apparatus described below. It is possible that a system, apparatus or process described below is not an embodiment of any claimed embodiment. Any embodiment disclosed below that is not claimed in this document may be the subject matter of another protective instrument, for example, a continuing patent application, and the applicants, inventors or owners do not intend to abandon, disclaim or dedicate to the public any such embodiment by its disclosure in this document.

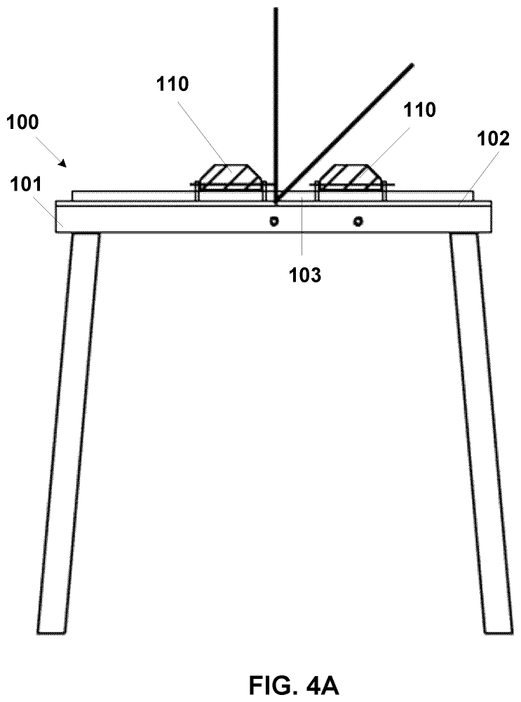

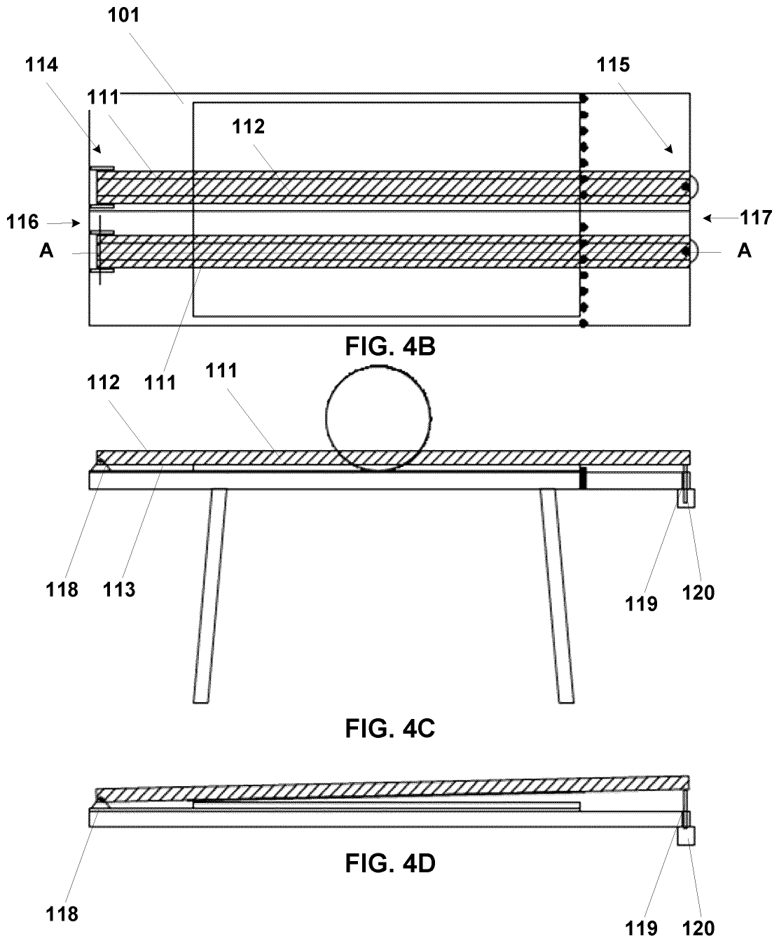

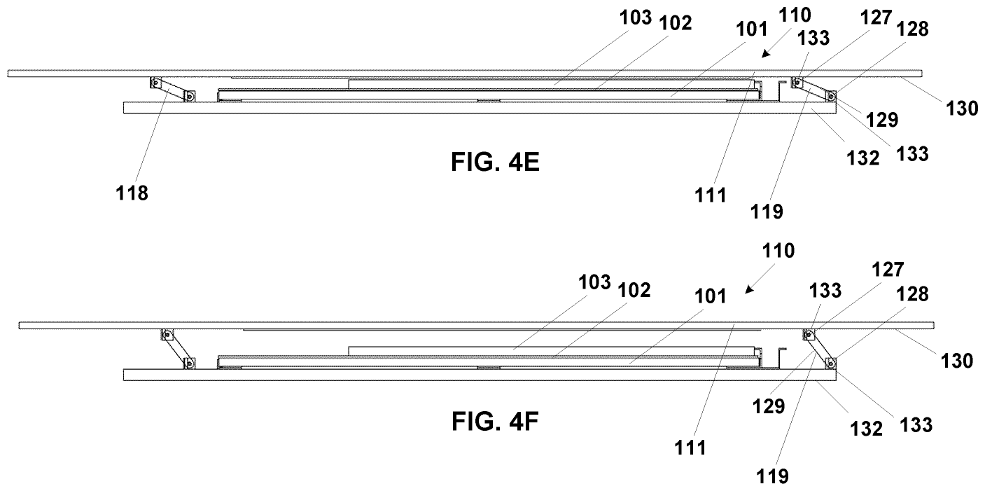

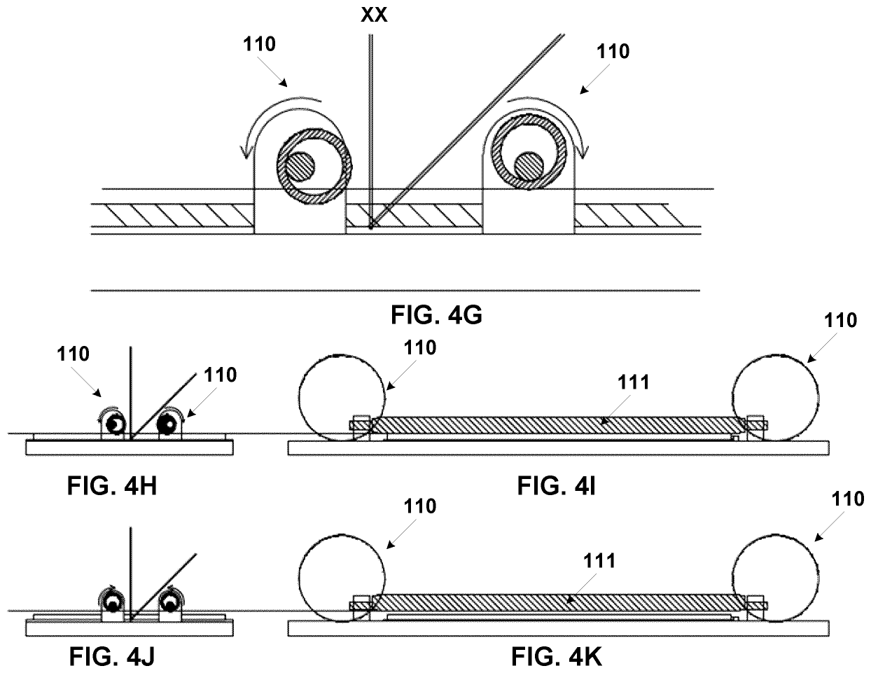

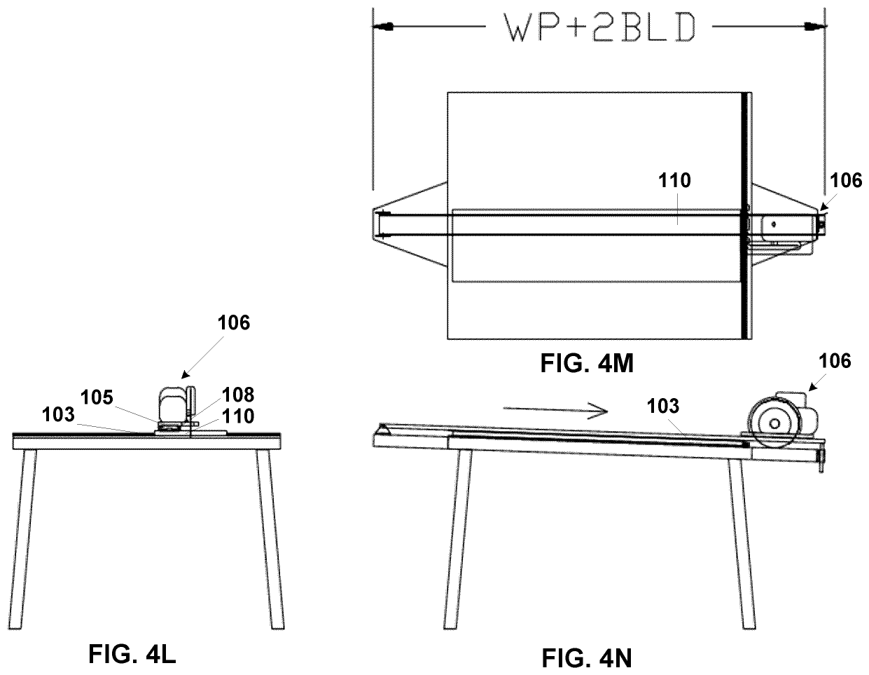

FIG. 4A is an end view of a saw system 100 according to at least one embodiment described herein. Saw system 100 is intended to be used with a saw for cutting a hard workpiece, such as but not limited to ceramic and/or porcelain tiles.

Saw system 100 includes a base 101 with an upper surface 102. The base 101 is used to support a workpiece 103 being cut. The base 101 may be made of relatively stiff material, such as but not limited to a material that will readily accept a screw for mounting various jigs, fixtures and stops, such as but not limited to plywood.

Herein, the workpiece 103 to be cut is a hard material such as but not limited to a ceramic, porcelain, marble, or slate tile. For example, the workpiece 103 may be a stone tile, a cementitious paver or a porcelain tile such may be used in indoor or outdoor applications. Commonly, when cutting hard materials such as but not limited to ceramic tiles, water is used during cutting to cool a blade of the saw. In at least one embodiment described herein, the base 101 of system 100 is sloped relative to a ground to provide for water on upper surface 102 of base 101 to run off upper surface 102.

Base 101 may be readily replaced by the owner/contractor on an as needed basis. Base 101 may be covered with a replaceable plastic sheet to protect the base from water. In some uses of system 100, base 101 and/or the plastic sheet may be covered with a drainage mat made of, for example, a flexible polymeric material that includes openings therein that provide for passage of water away from a saw cutting the workpiece and/or and away from a top surface of the drainage mat. In at least one embodiment described herein, the drainage mat may be approximately ¼ inch thick. Drainage mats are discussed in greater detail below.

To cut a workpiece 103, the workpiece 103 is placed on upper surface 102 of base 101, or, alternatively, on top of a drainage mat positioned on upper surface 102. The drainage mat serves to dissipate water away from a blade of the saw and to provide a clean work surface (i.e., a surface that is not covered with water used during cutting). The drainage mat may also provide a space below the workpiece for the tip of the blade of the saw to travel within when cutting the workpiece without cutting the base 101.

The saw systems described herein include at least one clamp 110. In some embodiments, the systems may include more than one clamp, such as two clamps 110 Clamp 110 is movably mounted to the base 101. Clamp 110 moves between a raised position and a lowered position. When in the lowered position, the clamp 110 secures, or presses down on the workpiece to secure it to upper surface 102 of the base 101 to restrict movement of the workpiece relative to the base 101 while the saw 106 cuts the workpiece. When in the raised position, the clamp 110 is vertically spaced from the workpiece and provides for the workpiece to be moved relative to the base 101.

FIGS. 4B-4D shows that the clamp 110 includes an elongate body 111 having a top surface 112, a bottom surface 113, a first end 114 and a second end 115. The first end 114 is positioned adjacent to a first side 116 of the base 101 and the second end 115 of the clamp 110 is placed adjacent to a second side 117 of the base 101. The clamp 110 is secured to the base 101 by a first connector 118 and a second connector 119. The first connector 118 is configured to secure the first end 114 of the elongate body 111 to the base 101 at the first side 116 of the base 101 and the second connector 119 is configured to secure the second end 115 of the elongate body 111 to the base 101 at a second side 117 of the base 101. Elongate body has a longitudinal axis AA (see FIG. 4B).

At least one of the first connector 118 and the second connector 119 is configured to provide for the elongate body 111 of the clamp 110 to move between a raised position where the elongate body 111 is disengaged from an upper surface of the workpiece and a lowered position where the elongate body 111 abuts the top surface of the workpiece and secures, i.e., tightly holds, the workpiece against upper surface 102 of the base 101.

For example, in the example shown in FIGS. 4A-4D, the first connector 118 is a hinge and the second connector 119 includes an actuator 120. In this embodiment, the second connector 119 secures the second end 115 of the elongate body 111 to the base 101 when the elongate body 111 is in its lowered position and when the elongate body 111 is in its raised position. The actuator 120 moves the elongate body 111 between the lowered position and the raised position. The actuator 120 also at least partially contributes to the system 100 applying a predetermined force onto the elongate body 111 to retain the elongate body 111 in the lowered position during cutting. Actuator 120 may be a manual actuator or may be a powered actuator. The actuator 120 may be a mechanical actuator (e.g., screw), an electrical actuator, or any other actuator appropriate for moving the clamp 110 between its raised and lowered positions. In at least one embodiment, the actuator 120 is a direct current (DC) actuator that stops downward movement of the elongate body 111 when a threshold pressure is reached. In at least one embodiment, the actuator 120 is mechanical actuator with a screw with a handle. The actuator 120 may optionally include a slip clutch. In at least one embodiment, the actuator 120 may be a hydraulic cylinder the extends and retracts to control movement of the elongate body of the clamp.

In the example embodiment shown in FIGS. 4E and 4F, the first connector 118 and the second connector 119 are each links that are each pivotally coupled to an end of the elongate body 111 and to the base 101. In this embodiment, the links 118 and 119 together move the elongate body 111 between its raised position and its lowered position. In this embodiment, the elongate body 111 remains parallel with upper surface 102 of the base 101 as the elongate body 111 moves between its raised position and its lowered position.

Each of links 118 and 119 include a first mounting portion 127 for coupling to elongate body 111, a second mounting portion 128 and a linkage member 129. First mounting portion 127 is mounted to an underside 130 of elongate body 111. Second mounting portion 129 may be mounted to upper surface 102 of base 101 or, alternatively, to a lower member 132 of clamp 110, in any manner known to one skilled in the art, such as but not limited to being bolted thereto, fastened thereto, welded thereto, or the like. Each of first mounting portion 127 and second mounting portion 128 are configured to provide for linkage member 129 to rotate relative to elongate body 111 and body 101, a lower member 132, to provide for elongate body 111 to move between its raised position and its lowered position while remaining parallel to upper surface 102 of base 101. For example, each of first mounting portion 127 and second mounting portion 128 may include a pin 133 configured to pass through a respective aperture of linkage member 129 to provide for linkage member 129 to rotate relative to elongate body 111 and body 101.

It should be understood that although FIGs, 4C-4F show one first connector 118 and one second connector 119 coupled to elongate body 111 and base 101, system 100 may include two or more first connectors 118 and second connectors 119 for each clamp 110. For example, in one embodiment, system 100 may include two links 118 and two links 119. In this embodiment, the two links 118 may be positioned beside each other and spaced across a width of the elongate body 111 and the two links 119 may be positioned beside each other and spaced across a width of the elongate body.

Clamp 110 may be positioned on either side of a cut line XX, for example on a same side as a saw head or saw drive or blade drive or motor 109 of the saw 106 cutting the workpiece or on another side of the saw head or saw drive 109 of the saw 106 cutting the workpiece.

In another embodiment described herein, the clamp 110 may be a rotary clamp that extends along a portion of the workpiece 103 and rotates between its raised and lowered positions. FIGS. 4G to FIG. 4K show an example embodiment of a clamp 110 that rotates between its raised position and lowered position. Rotation of the clamp 110 may be driven by one or more actuators 120, such as but not limited to a manual actuator or a powered actuator. In the case where more than on actuator 120 is present to rotate the clamp 110 between its lowered position and its raised position, two actuators may be initiated together or separately.

In at least one embodiment of the saw systems described herein, the clamp 110 may also be configured to direct motion of the carriage 105, and a saw 106 carried by the carriage 105, along a cut line XX to provide for the saw 106 to cut the workpiece (e.g., along the cut line). The cut line XX is typically parallel to and spaced from a longitudinal axis AA of the elongate body 111 of the clamp 110. An example of this is type of clamp is shown in FIG. 4L, FIG. 4M and FIG. 4N.

In some embodiments, the saw systems described herein also include a carriage 105 to carry a cutting tool (e.g., a saw). Carriage 105 carries a saw 106 to cut workpiece 103. Carriage 105 may be configured to accommodate different types of saws. Carriage 105 is configured to slide along a guide 107 of clamp 102 of the saw system.

Saw 106 includes a blade 108 for cutting the workpiece 103 and a blade drive 109 for rotating the blade 108. As noted above, during cutting of a workpiece, a contact area between the blade 108 and the workpiece may be constantly flushed with water to cool the blade 108 during the cut. In at least one embodiment, the saw 106 is a handheld circular saw that can cut the workpiece at an angle in a range of about 45 degrees to 90 degrees. Saw 106 is typically configured on carriage 105 to climb-cut (i.e., feeding the workpiece into the saw in the same direction as the blade 108 rotates) the workpiece, however, saw 106 may also be configured for conventional cutting (i.e., feeding the workpiece into the saw in a different direction than the blade 108 rotates). Embodiments that include a carriage 105 are described in greater detail below.

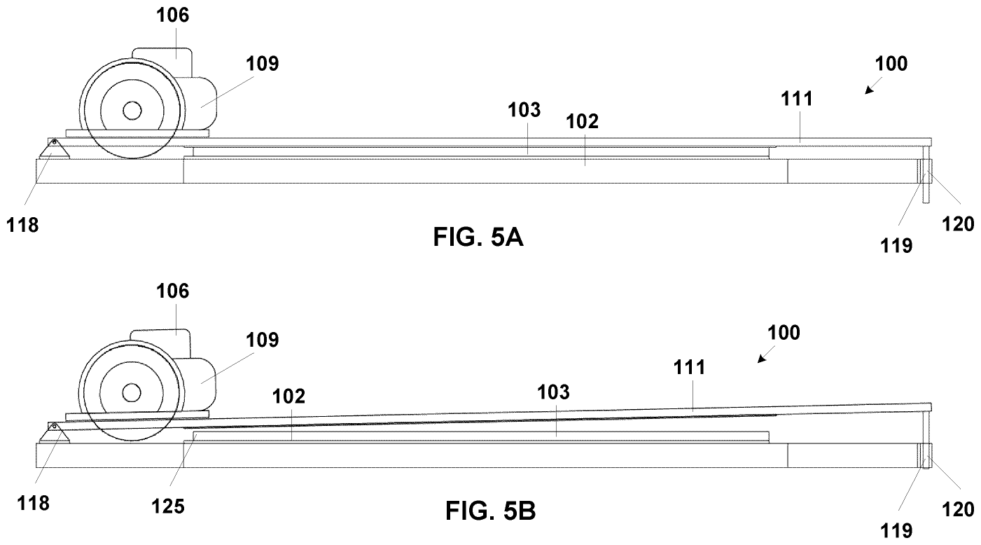

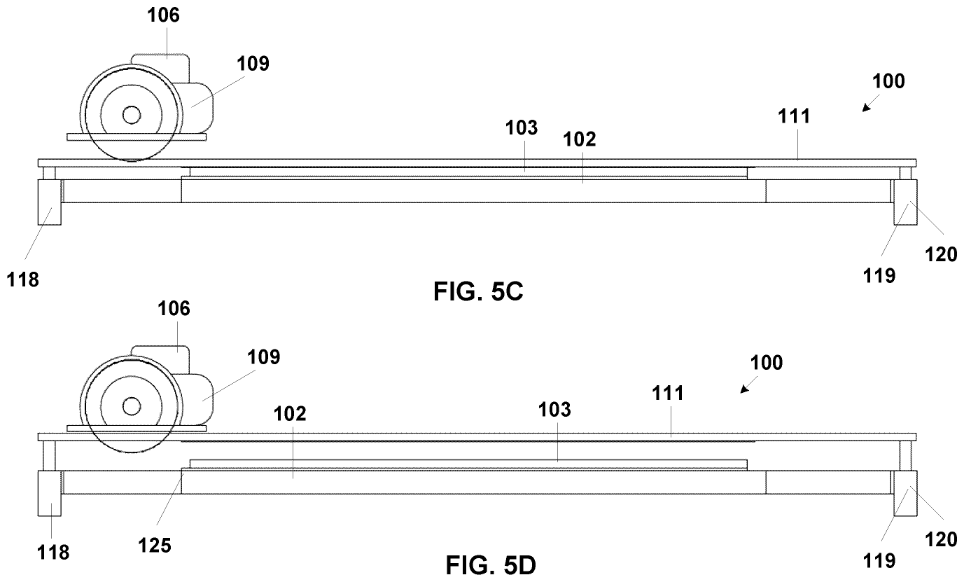

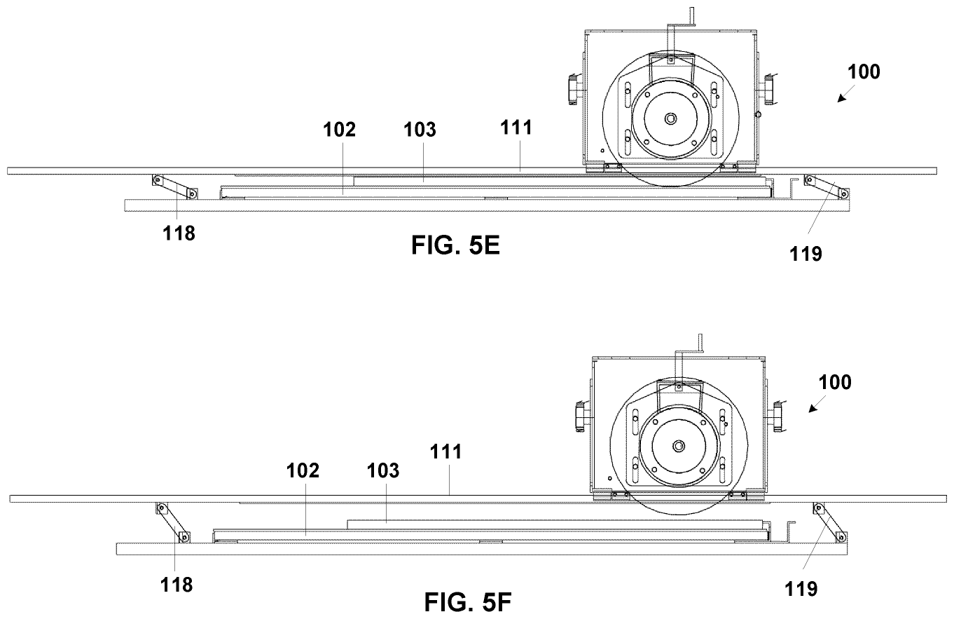

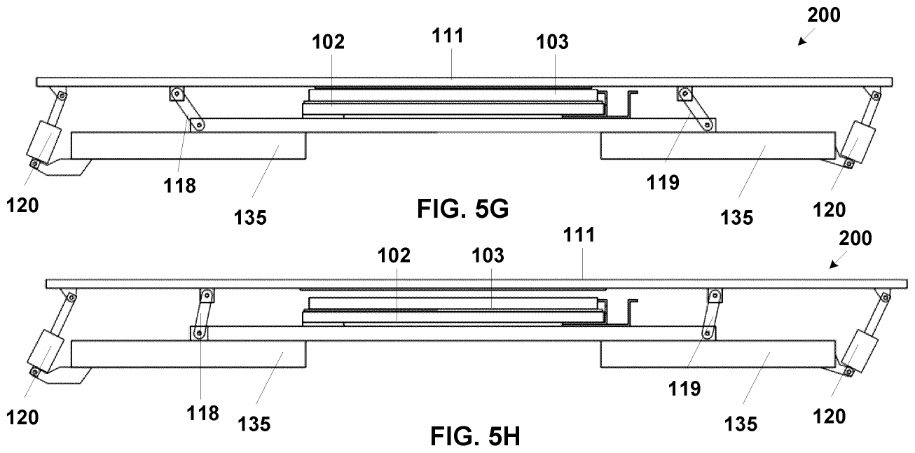

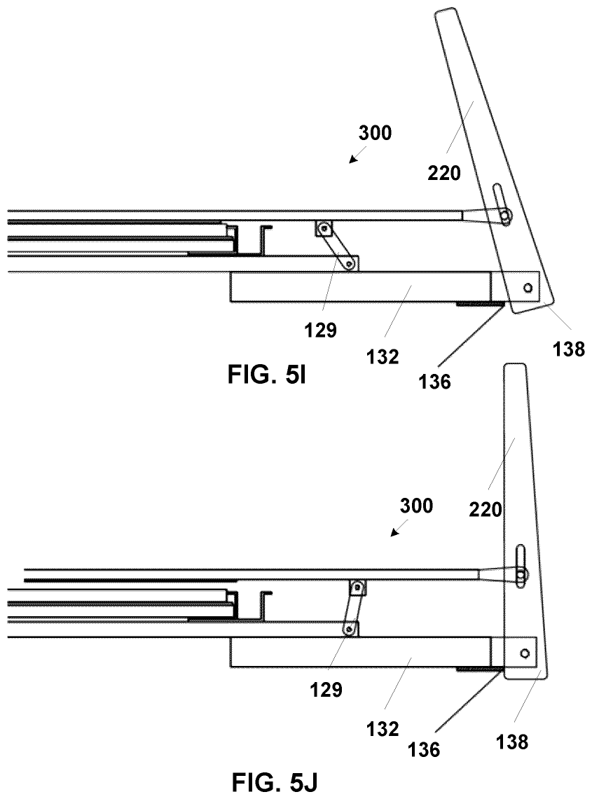

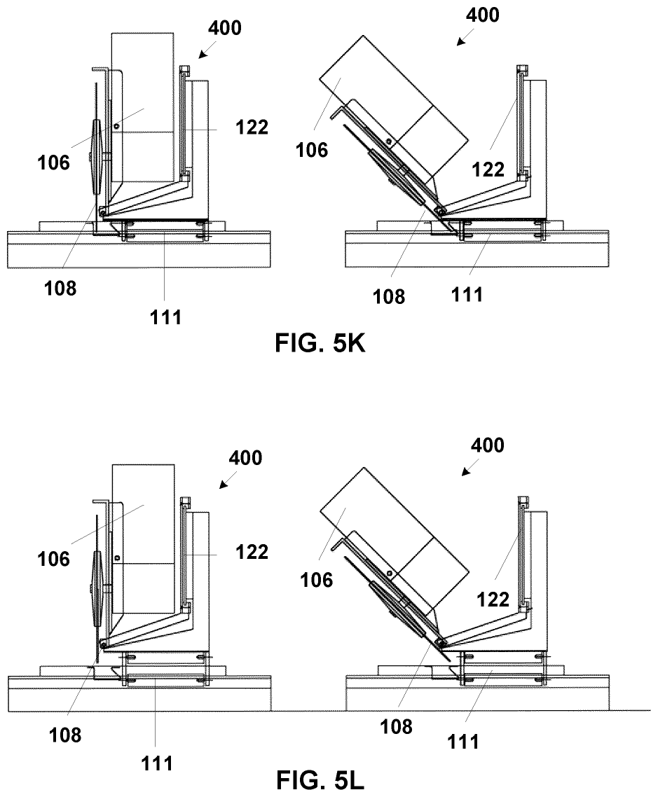

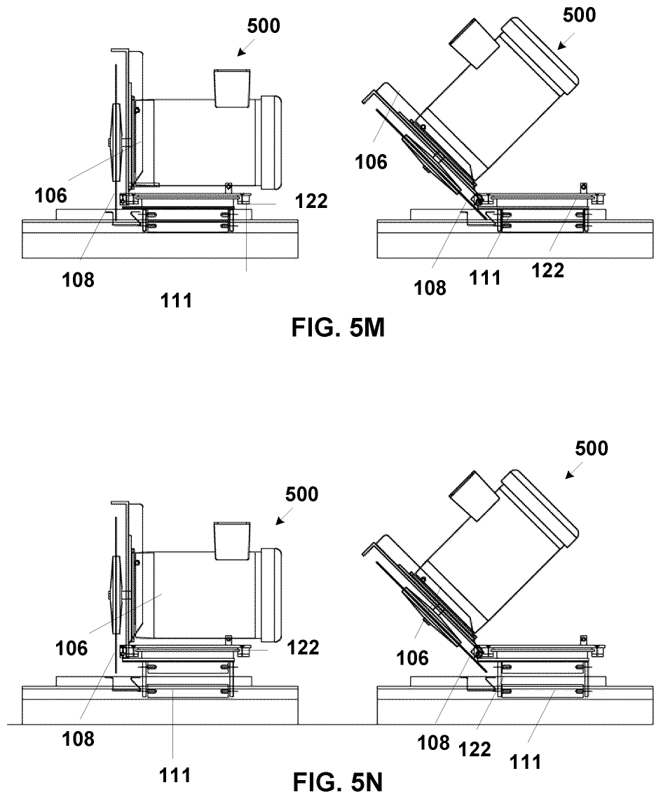

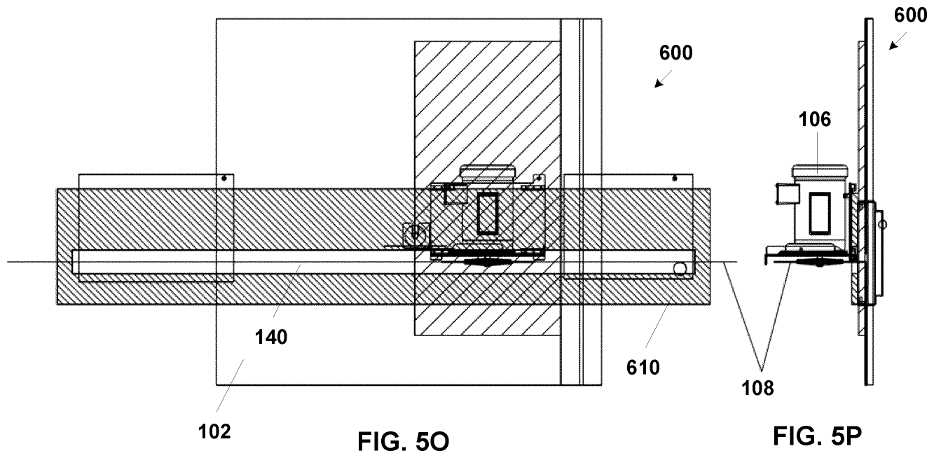

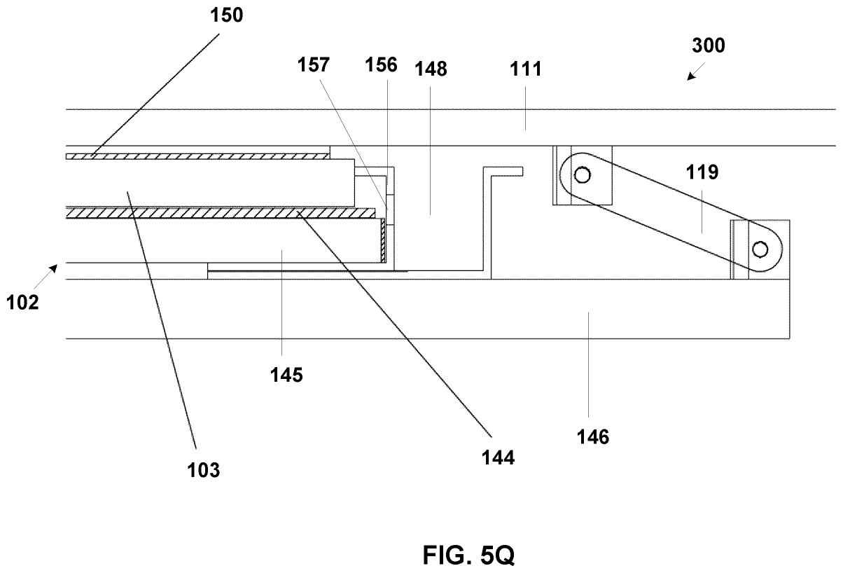

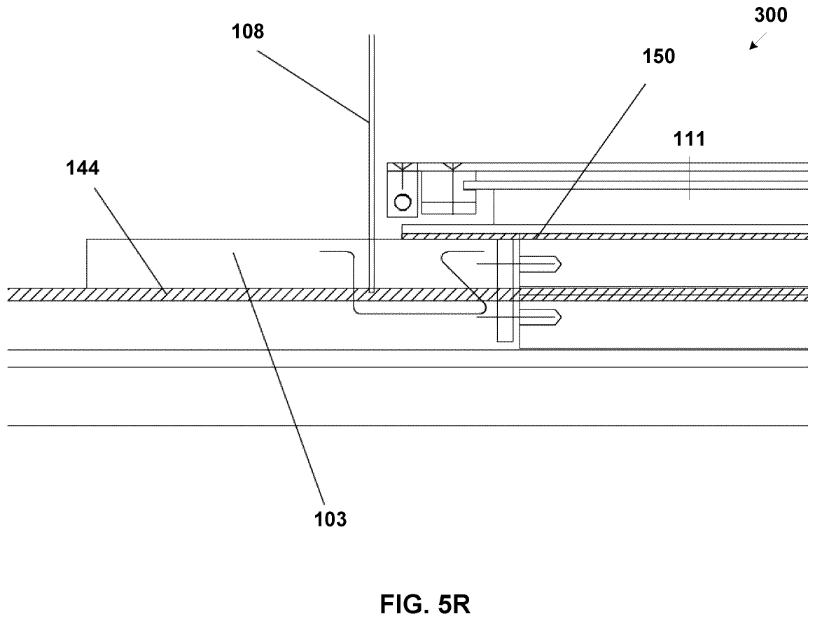

In embodiments where the clamp 110 is configured to direct motion of the carriage 105 (e.g., a direction parallel to a longitudinal axis AA of the elongate body 111), the clamp 110 includes a guide 122. In at least one embodiment, the guide 122 is integral with elongate body 111. Examples of this are shown in FIG. 4L, FIG. 4M and FIG. 4N. In at least one embodiment, the guide 122 and elongate body 111 are separate components that are coupled to each other. One example of this arrangement is shown in FIGS. 5K-5N. It should be understood that the guide 122 and the elongate body 111 may be coupled to each other in any manner that provides for the elongate body 111 to secure the workpiece to the base 101 and provides for the guide 122 to guide the carriage 105, carrying a saw 106, along a cut line 121.

The guide 122 is typically made of metal and may have a length in a range of about two times a length of the saw 106 plus a maximum length of the workpiece (e.g., 15 cm×2+50 cm=80 cm).

In at least one embodiment, the elongate body 111 of clamp 110 is positioned beneath a blade drive (motor) 109 of the saw 106. In at least one embodiment, the elongate body 111 is positioned between a blade drive 109 of the saw 106 and the upper surface 102 of the base 101. In at least one embodiment, the elongate body 111 is positioned between a blade drive 109 of the saw 106 and the workpiece. In at least one embodiment, the elongate body 111 and the carriage 105 are positioned beneath a blade drive 109 of the saw 106. In at least one embodiment, the elongate body 111 and the carriage 105 are positioned between a blade drive 109 of the saw 106 and the workpiece. In at least one embodiment, the elongate body 111 and the carriage 105 are positioned between a blade drive 109 of the saw 106 and the upper surface 102 of the base 101. In at least one embodiment, the elongate body 111 is parallel to a blade 108 of the saw 106.

FIG. 5A is a side view of a clamp 110 of the saw system 100 of FIG. 4A, according to at least one embodiment. The clamp 110 is shown at a lowered position in FIG. 5A. FIG. 5B is another side view of the clamp 110 but shown at a raised position.

In FIGS. 5A and 5B, the clamp 110 is coupled to the base 101 by a hinge 118. The hinge 118 is positioned on the base 101 adjacent to an edge 125 of the base 101. The hinge 118 is positioned at a first end 114 of the elongate body 111 of clamp 110. To secure the clamp 110 to the base 101 in its lowered position, the clamp 110 also includes second connector 119 at the opposite end 115 of the elongate body 111 of clamp 110, the second connector 119 including an actuator 120. The second connector 119 secures the second end 115 of the elongate body 111 to the base 101 when the elongate body 111 is in its lowered position and in its raised position. The actuator 120 moves the elongate body 111 between the lowered and raised positions. The actuator 120 also provides a predetermined force for retaining the elongate body 111 in the lowered position during cutting. The hinge 124 is slightly spaced apart (e.g., upwardly) from the base 101 to provide for the clamp 110 to be parallel with upper surface 102 of the base 101 when the clamp 110 is in its lowered position.

FIG. 5C is a side view of the clamp 110 being coupled to the base 101 by another embodiment of a first connector 118 and a second connector 119. The first connector 118 and a second connector 119 at opposed ends of the elongate body 111 of clamp 110 and are used to provide for elongate body 111 to press down on and hold the workpiece 103 tightly against upper surface 102 of the base 101. In the embodiment of FIGS. 5C and 5D, as well as further embodiments described below, the first connector 118 and a second connector 119 are configured to provide for the elongate body 111 of clamp 110 to be parallel with upper surface 102 of the base 101 when the elongate body 111 of clamp 110 is in its raised position, in its lowered position and as it moves between its raised and lowered positions.

FIG. 5C shows clamp 110 having a first connector 118 and a second connector 119 configured to provide for the elongate body 111 of clamp 110 to be parallel with upper surface 102 of the base 101 when the elongate body 111 of clamp 110 is in its raised position, in its lowered position. FIG. 5D shows the clamp 110 of FIG. 5C at its raised position.

FIG. 5E is a side view of a system 100 according to another embodiment. In this embodiment, the clamp 110 is secured to the base 101 by a first connector 118 and a second connector 119, where each of the first connector 118 and the second connector 119 are linkage connectors as described previously with reference to FIGS. 4E and 4F. FIG. 5E shows the clamp 110 at a lowered position and FIG. 5F shows the clamp 110 at a raised position.

It should be understood that the first connector 118 and a second connector 119, in any embodiment described herein, may be manually actuated or may be actuated by one or more actuators 120. FIG. 5G is a side view of a system 200 having a clamp 110. In this embodiment, the clamp 110 is secured to the base 101 by a first connector 118 and a second connector 119, where each of the first connector 118 and the second connector 119 are linkage connectors as described previously with reference to FIGS. 4E and 4F. However, in this embodiment, clamp 110 includes two actuators 120, one actuator positioned at either end of the elongate body 111. Actuators 120 may each be a pneumatic, electric, mechanical, or hydraulic actuator, or the like. FIG. 5H shows the clamp 110 at a lowered position and FIG. 5F shows the clamp 110 at a raised position. In this embodiment, the actuators 120 are each coupled directly to elongate body 111 of clamp 110 and to a lower support member 135 of system 200.

FIG. 5I is a magnified side view of a saw system 300 according to at least one embodiment described herein showing a manual actuator 220 and a clamp 110 at a lowered position. Here, the manual actuator 220 is coupled to elongate member 111 so that as the manual actuator is actuated (e.g., in a back-and-forth manner) the clamp 110 is moved between its raised and lowered positions. FIG. 5J is a magnified side view of the saw system 300 of FIG. 5I showing the manual actuator 220 and the clamp 110 at a raised position. Here it is shown that the first connector 118 and the second connector 119 have a resting position where linkage member 129 has an angle that is less than about 90 degrees (e.g., about 85 degrees) with lower member 132. Clamp 110 is held in the raised position (e.g., movement of clamp 110 to the raised position by actuator 220) by a block 136 positioned on an underside of lower member 132. Lower end 138 of actuator 220 abuts the block 136 upon rotating and movement of the clamp 110 is stopped. Clamp 110 is held in its lowered position by gravity. In some embodiments, clamp 110 is held in its lowered position by a positive force (e.g., by an actuator). In some embodiments, clamp 110 may be locked in its lowered position.

FIG. 5K is two end views of a saw system 400 according to at least one embodiment described herein showing a saw 106 of the saw system 400 in a neutral position and in a pivoted position, respectively. In both views of FIG. 5K, the clamp 110 is at a lowered position. In both views of FIG. 5L, the clamp 110 is at a raised position.

To provide for pivoting of the saw 106, in this embodiment, guide 122 and elongate body 111 of clamp 110 are separate components that are connected to each other. In FIG. 5K and FIG. 5L, guide 122 is a rail that is oriented vertically relative to the base 101 and shaped to slidingly couple with carriage 105 of saw 106.

In FIG. 5K, the saw 106 of the saw system is shown as being tiltable between 90 and 45 degree angles. In these embodiments where the saw 106 is tiltable, a point of rotation for angle cutting is above the elongate body 111 and on a same side of the blade 108 as the guide 122.

FIG. 5M is two end views of a saw system 500 according to at least one embodiment described herein showing a saw 106 of the saw system 500 in a neutral position and in a pivoted position, respectively. In both views of FIG. 5M, the clamp 110 is at a lowered position. In both views of FIG. 5N, the clamp 110 is at a raised position.

To provide for pivoting of the saw 106, in this embodiment, guide 122 and elongate body 111 of clamp 110 are integral with each other (e.g., guide 122 is horizontally oriented). In FIG. 5M and FIG. 5N, guide 122 is a rail that is oriented vertically relative to the base 101 and shaped to slidingly couple with carriage 105 of saw 106.

In FIG. 5M, the saw 106 of the saw system is shown as being tiltable between 90 and 45 degree angles. In these embodiments where the saw 106 is tiltable, a point of rotation for angle cutting is also above the elongate body 111 and on a same side of the blade 108 as the guide 122.

FIG. 5O is a top view of a saw system 600 according to at least one embodiment described herein showing a clamp 610 having a slot 140. In some instances, it may be desirable to have a portion of clamp 610 on both sides of blade 108 to hold workpiece 103 against base 101. In this embodiment, clamp 610 is wider than previous embodiments of clamp 110 and clamp 610 forms a slot 140 for the blade 108 to travel within. FIG. 5P is an end view of the saw system 600 of FIG. 5O.

FIG. 5Q is a magnified side view of the saw system 300 of FIGS. 5I and 5J showing a linkage connector 119 and a second water trough 148. FIG. 5R is an end view of the saw system 300 of FIG. 5Q.

FIG. 5Q shows a workpiece 103 sitting on a drainage mat 144, that in turn sits on top of a table 145 of base 101. System 300, and specifically base 101, is constructed to direct, channel and/or recirculate water, such as but not limited to water used by saw 106 when cutting workpiece 103. Drainage mat 144 is a free-draining material and is locally compliant and structurally strong over a wider area. Drainage mat 144 include openings extending vertically therethrough and horizontally therethrough to provide for the passage of water, for example present in the cut made by the saw 106. Drainage mat 144 channels water away from the cut to assist in maintaining a wet cut and simultaneously providing for water to drain away to be recycled (e.g., into a water trough 148). In this example, the work surface remains clear and relatively dry.

FIG. 5Q also shows a conformity mat 150 positioned on an underside 152 of elongate body 111 of clamp 110. In this embodiment, the conformity mat 150 is adhered to underside 152 of elongate body 111 of clamp 110. The conformity mat 150 may be positioned on at least a portion of an underside 152 of the elongate body 111 of the clamp 110. The conformity mat 150 is made of a material that is softer and stickier than the drainage mat 144 material. During cutting, when at least a portion of the underside of the elongate body 111 includes a conformity mat 150, the workpiece 103 may be rigidly secured between the drainage mat 144 (on the bottom) and the elongate body 111 of the clamp 110. The conformity mat 150 and drainage mat 144 may provide for absorb vibrations during cutting and provide for smoother cuts. FIG. 5R shows a magnified end view of a clamp and saw system showing the drainage mat 144 and a conformity mat 150.

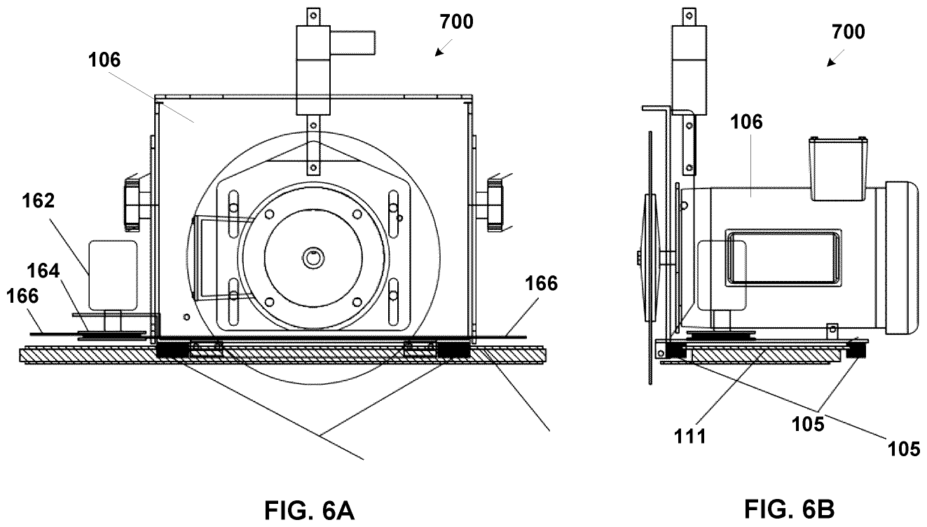

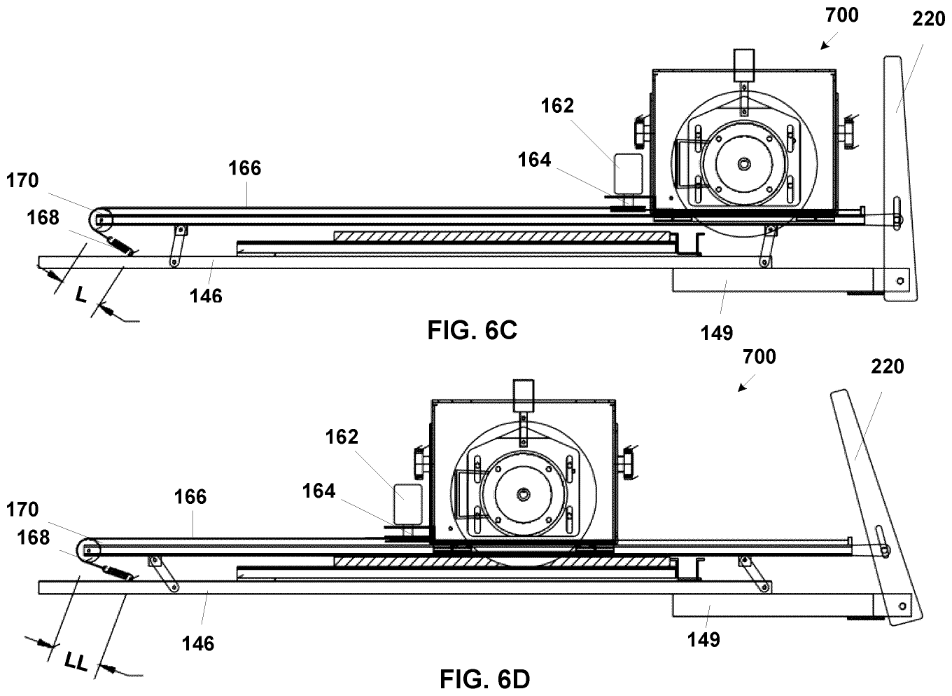

FIG. 6A is a magnified side view of a saw system 700 according to at least one embodiment described herein. System 600 includes a saw 106 carried by a carriage 105, the carriage 105 having a powered actuator 160 mounted to the carriage 105. FIG. 6B is an end view of the saw system of FIG. 6A.

FIG. 6C is a side view of the saw system 700 of FIG. 6A showing the clamp 110 at a raised position. FIG. 6D is a side view of the saw system 700 of FIG. 6A showing the clamp 110 at a lowered position and the saw 106 cutting the workpiece 103.

Powered actuator 160 is configured to drive the carriage 105 carrying the saw 106 from a home position to a stop position along the longitudinal axis AA of the clamp 110 for the saw 106 to cut the workpiece 103. Powered actuator 160 comprises a carriage-mounted drive motor 162 with a drum 164 and a wire 166 having a variable length. The variable length of wire 166 is provided for by spring tensioner 168. Referring to FIGS. 6C and 6D, carriage-mounted drive motor 162 is configured to rotate the drum 164 upon actuation. Wire 166 is coupled to manual actuator 220, wraps around drum 164, passes around a wheel 170 at second end 115 of the elongate body 111 and couples to the spring tensioner 168. As the manual actuator 220 is pushed forward, spring tensioner 168 extends (e.g., to a length LL; LL being greater than length L, described below) and applies tension to wire 166. When wire 166 is under tension, it engages drum 164 and rotation of drum 164 will drive the carriage 105 forward. When actuator 220 is pulled in a rearward direction (e.g., by a user), spring tensioner 168 compresses (e.g., to length L) and relieves the tension on wire 166. When wire 166 is not under tension, it engages drum 164 and rotation of drum 164 will not drive the carriage 105. At this point, a user may manually pull the carriage 105 rearwardly towards its home position. In at least one embodiment, having the carriage-mounted drive motor 162 mounted to carriage 105 provides for wire 166 to not fall off when its tension is relieved.

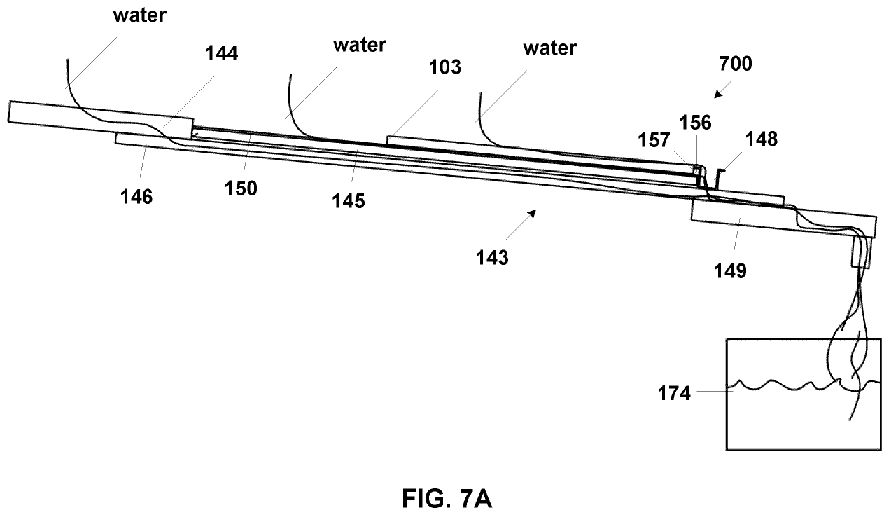

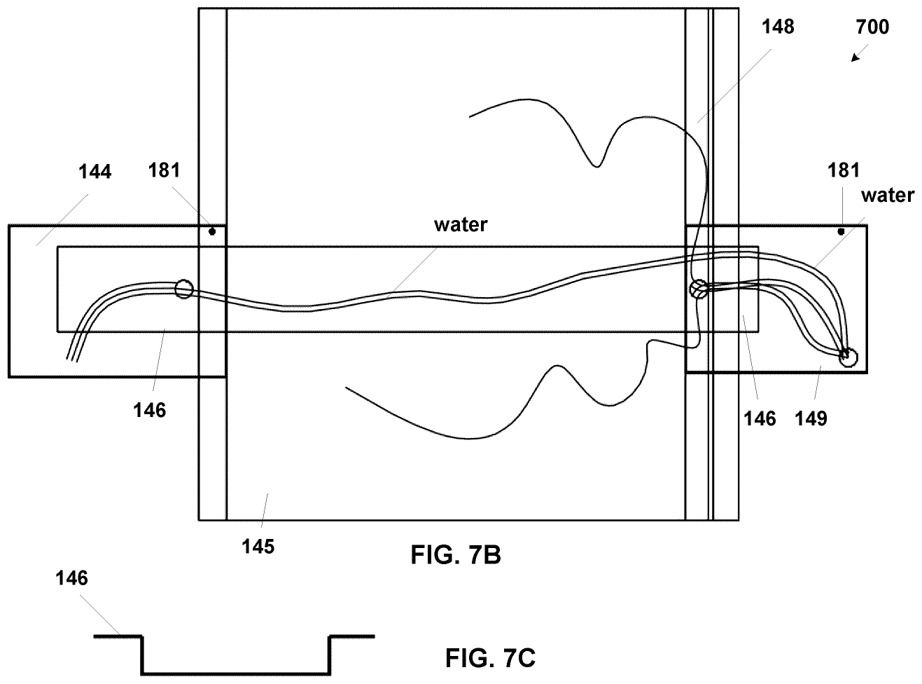

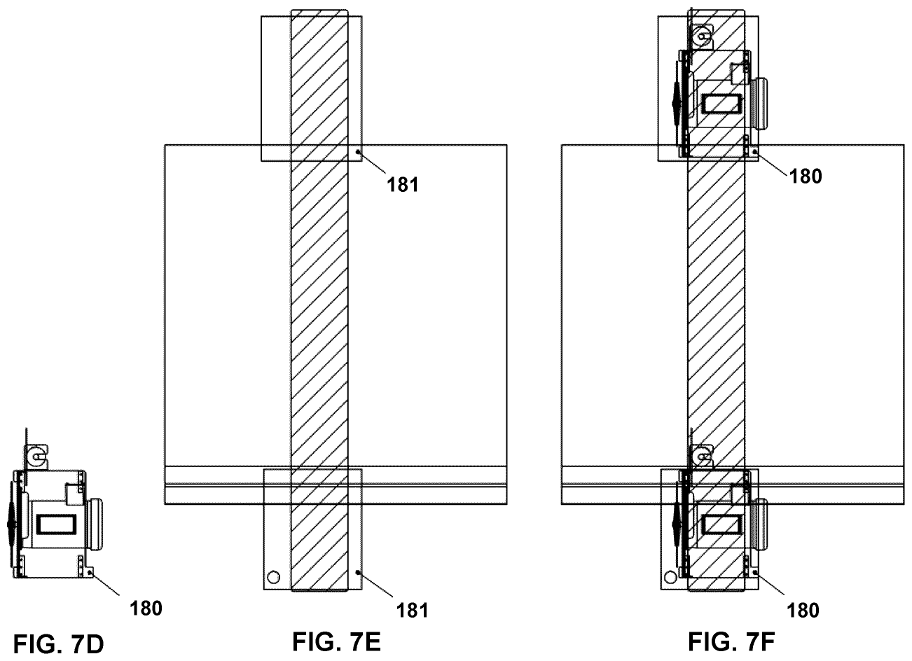

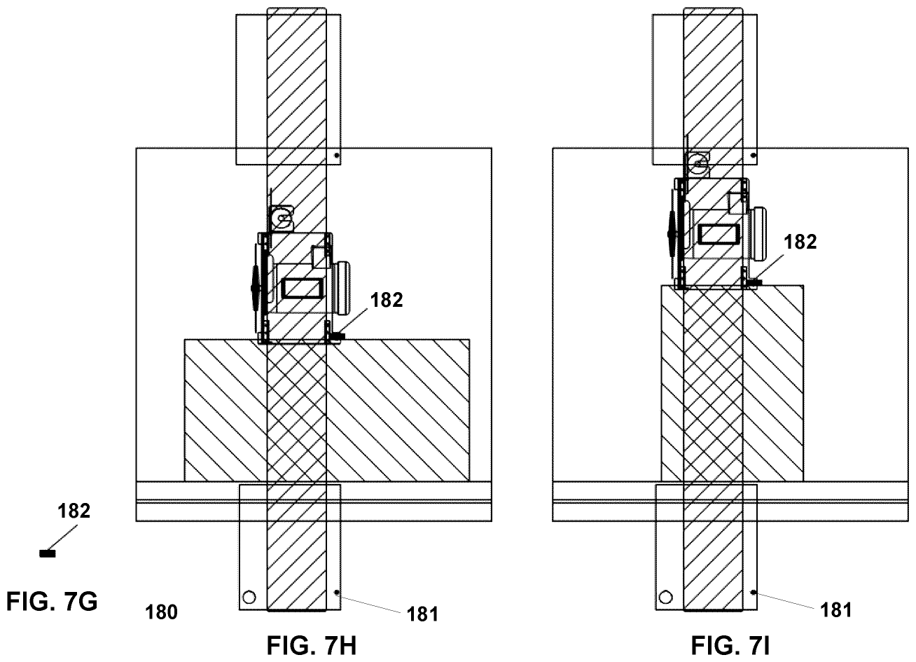

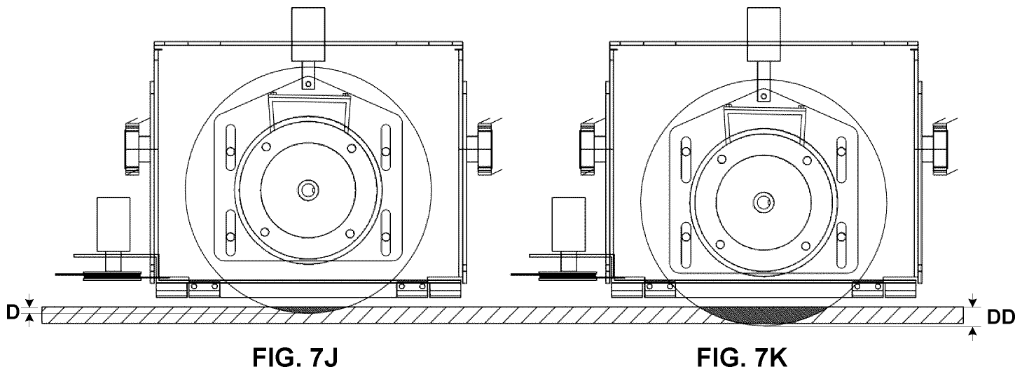

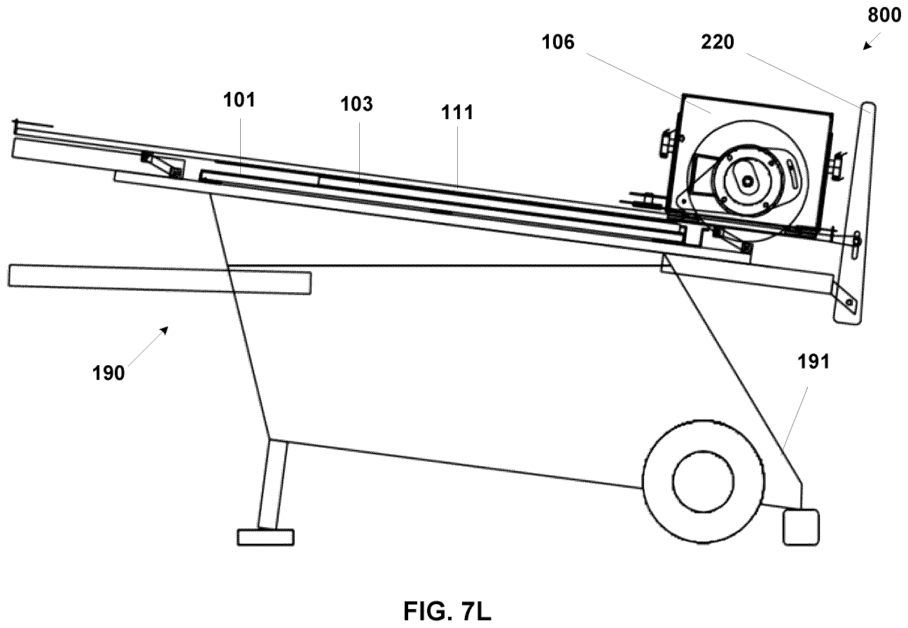

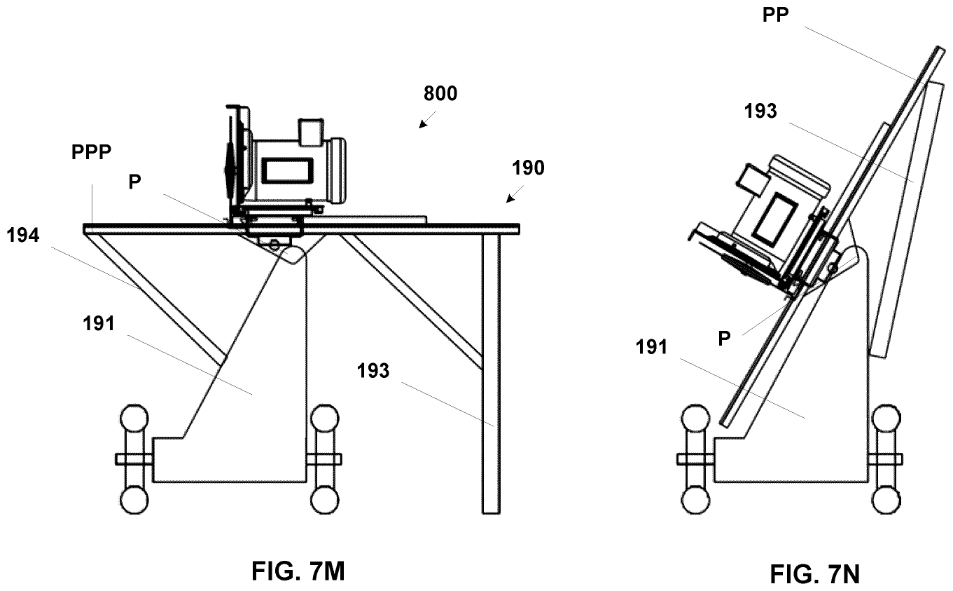

FIG. 7A is a side view of a portion of saw system 700 showing a water control system 143 thereof. FIG. 7B is a top view of the system 700 of FIG. 7A. Water control system 147 includes a first pan 144 positioned adjacent to second end 115 of elongate body 111 (not shown in FIG, 7A for clarity), a first water trough 146 extending underneath table 145, a second water trough 148 adjacent to first end 114 of elongate body 111, a pan 149 below second water trough 149 and a water tank 174. Water control system 147 controls water used by saw 106 when cutting workpiece 103.

First pan 144 is positioned at second end 115 of elongate body 111 to collect water used by saw 106 when near or adjacent to the stop position of carriage 105. First pan 144 is fluidly coupled to first water trough 146 extending underneath table 145 such that water collected in first pan 144 drains into first water trough 146. First water trough 146 directs the water in a direction towards pan 149 positioned at an opposite end of base 101. In at least one embodiment, first water trough 146 is attached to table 145 and constructed of steel (or a similar material) and provides structural rigidity to the system 700. First water trough 146 is shown in cross-section in FIG. 7C. First water trough 146 carries water from near second end 115 of elongate body 111 to an opposite side of base 101.

As shown in FIG. 7A, base 101 (and table 145 thereof) is tilted downwardly (i.e., towards the second water trough 148) (e.g., by an angle of X degrees, X being in a range of about 1 to about 22 degrees) to encourage movement of water (by gravity) along at least a top surface 102 of base 101 and/or workpiece 103 towards second water trough 148. Second water trough 148 is positioned at a lower end of workpiece 103 to collect water travelling along top surface of workpiece 103 and/or along top surface 102 of base 101 (e.g., along table 145 of base 101). Water collected in second water trough 148 is directed downwardly into first water trough 146. First water trough 146 is configured to provide for water therein to drain into pan 149 positioned thereunder and subsequently into a tank 174 positioned below the pan 149.

In at least one embodiment, water trough 148 is defined by two pieces of, for example, sheet metal. In at least one embodiment, an inner wall 156 (i.e., a wall nearest to workpiece 103) of second water trough 148 may include one or more openings 157 to receive water passing though drainage mat 144 and/or along an upper surface of table 145 below workpiece 103.

In at least one embodiment, manual actuator 220 is coupled (e.g., pivotally coupled) to pan 149 to provide structural support to manual actuator 220.

In at least one embodiment, one or more of connectors 118 and 119 are coupled to first water trough 146 (see for example FIGS. 6C and 6D). In at least one embodiment, spring 168 is coupled to first water trough 146.

FIG. 7D is a top view of a saw 106 of a saw system according to at least one embodiment described herein. FIG. 7D shows saw 106 having a proximity switch, or proximity sensor, 180 for sensing a position of saw 106 relative to base 101 and/or relative to workpiece 103 positioned thereon. Proximity switch 180 may be mounted on the saw 106 or carriage 105. FIG. 7E is a top view of a saw system with saw 106 having a proximity switch 180. FIG. 7E shows the system having two pins 181 for conveying a position of carriage 105 to the proximity switch 180. Proximity switch 180 can detect a position of the pins 181 and determine when the carriage 105 is at its home position (as shown at the bottom of FIG. 7F) and/or at its stop position (as shown at the top of FIG. 7F). FIG. 7F is a top view of the saw system of FIG. 7E showing a saw 106 at its home position and at its stop position.

FIG. 7G is a top view of a block 182 (i.e., a metal block) for conveying a position to the proximity switch 180 of the saw 106 of FIG. 7D. Block 182 may be positioned on base 101 at any point thereon to determine a stop position for carriage 105. FIG. 7H is a top view of a saw system according to at least one embodiment described herein showing the block of FIG. 7G being positioned at an end of a workpiece 103 of a first size. For example, as shown in FIG. 7H, block 182 may be positioned at an end of workpiece 103 to signify a stop position of carriage 105

FIG. 7I is a top view of a saw system according to at least one embodiment described herein showing the block of FIG. 7G being positioned at an end of a workpiece of a second size. FIG. 7I shows that block 182 may be attached to base 101 at a different position to control a length of travel of carriage 105 between its home position and stop position.

FIG. 7J is a magnified side view of a saw system according to at least one embodiment described herein showing a saw 106 of the system at a first cutting depth D. Saw 106 may be adjusted vertically within carriage 105 to control a depth D of a cut in workpiece 103. FIG. 7K is a magnified side view of the saw system of FIG. 7J showing saw 106 of the system at a second cutting depth DD.

In at least one embodiment of the saw systems described herein, the saw system includes a controller 188 configured to control operation of the saw 106 and/or carriage 105.

Controller 188 controls operation through the use of various modes of operation. For example, in a Manual Mode of operation, a user may manually start and/or stop blade drive 108 of saw 106, a user may manually start and/or stop a water pump (not shown) configured to supply water to the saw 106 and/or a user may manually start and/or stop powered actuator 160 that is configured to control travel of the carriage 105 (carrying saw 106) across base 101.

In another example, in a “Semi-Automatic Cycle” mode of operation, controller 188 may have a single start/pause button (not shown) to control at least one or more components described herein. For example, the Semi-Automatic Cycle may be started when a workpiece 103 is positioned on base 101, for example on table 145 thereof, and carriage 105 is in its home position. Proximity switches 180, described above, are communicatively coupled to controller 188 to provide a signal to controller 188 when in proximity to one of pins 181. Clamp 110 is configured such that, when the manual actuator 220 is in its downward position (i.e., elongate body 111 is pressing down on workpiece 103), proximity switch 180 will communicate to controller 188 that carriage 105 is at its home position. In turn, controller 188 provides power to the start/pause button such that a user may then initiate the Semi-Automatic Cycle mode of operation.

When the start/pause button is pressed by a user (i.e., when the user enters an input into the controller), a water pump of the system is powered on by the controller and water is provided to saw 106, blade drive 108 of saw 106 is activated by the controller and blade 109 begins to rotate, and powered actuator 160 is activated by the controller to initiate travel of carriage 105 in a forward direction (i.e., towards workpiece 103).

When proximity sensor 180 is in proximity to one of the pins 181, or block 182 (signifying the stop position of carriage 105), proximity sensor 180 sends a signal to controller 188 indicated that the carriage 105 is at its stop position. In response, controller 188 will deactivate the water pump, the blade drive 108 of saw 106 and the powered actuator 160. A user may then raise the clamp 110 manually, using manual actuator 220, to release the carriage 105 and manually return carriage 105 to its start position (as previously described).

If the start/pause button is depressed during the Semi-Automatic Cycle mode of operation (e.g., after activation of each of the water pump, the blade drive 108 of saw 106 and the powered actuator 160 but before the carriage 105 reaches its stop position), powered actuator 160 is deactivated to stop travel of carriage 105. The Semi-Automatic Cycle mode of operation may be re-started by depressing the start/pause button.

FIG. 7L is a side view of a saw system 800 including a cart 190 in a working position. Any one of the embodiments of saw systems described herein may include a cart 190. Cart 190 is configured to carry each of the components of the saw systems previously described herein.

FIG. 7M is an end view of the saw system 800 including a cart 190 of FIG. 7L, cart 190 shown in a working position. FIG. 7N is an end view of the saw system 800 including a cart 190 of FIG. 7L shown in a travel position. Cart 190 includes a tiltable frame 191 (optionally having wheels 192 for transport). Frame 191 is configured to tilt or pivot about point P (see FIG. 7M) to provide for the cart to move between its working position (shown in FIG. 7M), where one or more legs 193 are pivoted outwardly to engage the ground and support the saw system thereon, and its travel position (shown in FIG. 7N), where the one or more legs 193 are pivoted inwardly (i.e., about point PP (see FIG. 7M)) towards frame 191. Although only one leg 193 is shown in FIG. 7M, it should be understood that a second leg 193 may be present at an opposite end of frame 190 to stabilize base 101. Also, it should be understood that although base 101 is shown as being level with the ground in FIG. 7M, frame 191 may be configured to provide for base 101 to be sloped relative to the ground to provide for, for example, collection and/or management of water used during cutting, as previously described. Legs 193 may be adjustable in length to provide for stabilizing cart 190, such as on uneven ground. In at least one embodiment, when in the travel position, the cart 190 is less than or about 30 inches wide. Stabilizing members 194 may also be present and pivotable about a pivot point PPP to stabilize the saw system 800.

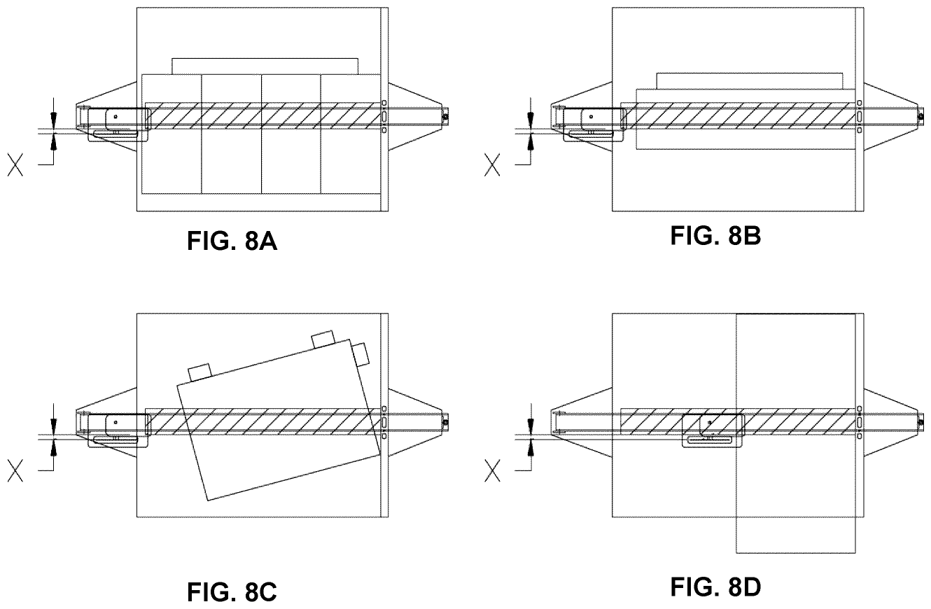

FIGS. 8A-8D are top views of a saw system according to at least one embodiment described herein showing how a workpiece 103 can be arranged on the base 101 and clamped by the clamp 110 for cutting in a simple and reliable manner. As shown therein, a blade cut path 195 is offset from a front face of the clamp by a distance X. Distance X may be in a range of 0.1 inches to about 3 inches, or about 1 inch, or less than 1 inch.

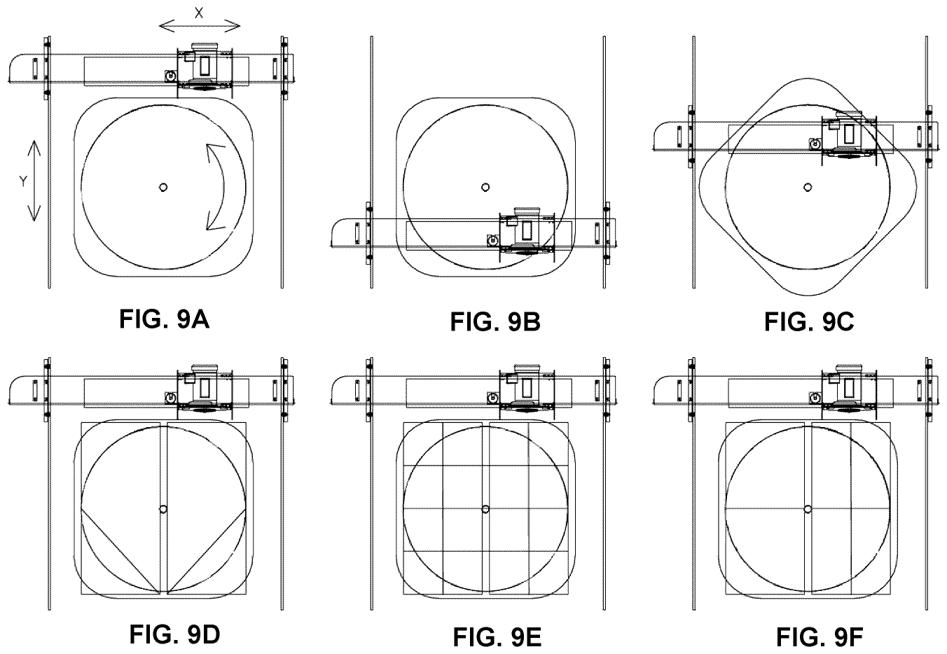

In some embodiments, the saw systems described herein may be used as a basis for providing a production system including automation. In this manner, FIGS. 9A-9F are top views of a saw system according to another embodiment described herein. In the saw system of FIGS. 9A-9F, the clamp is secured to the base and movable horizontally along the base. To provide for horizontal movement of the clamp, the clamp is mounted to rails positioned on sides of the base. FIG. 9A shows the clamp at a home position. The saw systems shown in this embodiment also include a turntable of the base that provides for rotation of the workpiece when the workpiece is supported on the turntable. The turntable may be configured to be automatically rotated or manually rotated (e.g., by a user). FIG. 9B shows the clamp having moved horizontally along the rails to a cutting position.

In the saw system of FIG. 9A-9F, various movements of components within the system may be automated or may be manual. For example, examples of movements that may be manual or may be automatic include vertical movement of the clamp between its raised and lowered positions, vertical movement of the carriage relative to the clamp, horizontal movement of the carriage along the clamp, horizontal movement of the clamp along the base, vertical movement of the saw (and saw blade) relative to the carriage, and rotation of a turntable of the base supporting the workpiece. To facilitate various levels of automation, any one or more of the above movements can be facilitated by components that are powered by cylinders, actuators, servo drives and the like.

FIG. 9C is a top view of the saw system of FIG. 9A showing the clamp at a cutting position and the turn table at a rotated position. FIG. 9D is a top view of the saw system of FIG. 9A showing a workpiece having angled cuts supported on a base. FIG. 9E is a top view of the saw system of FIG. 9A showing two workpieces having vertical and horizontal cuts supported on a base. FIG. 9F is a top view of the saw system of FIG. 9A showing two workpieces having vertical and horizontal cuts supported on a base.

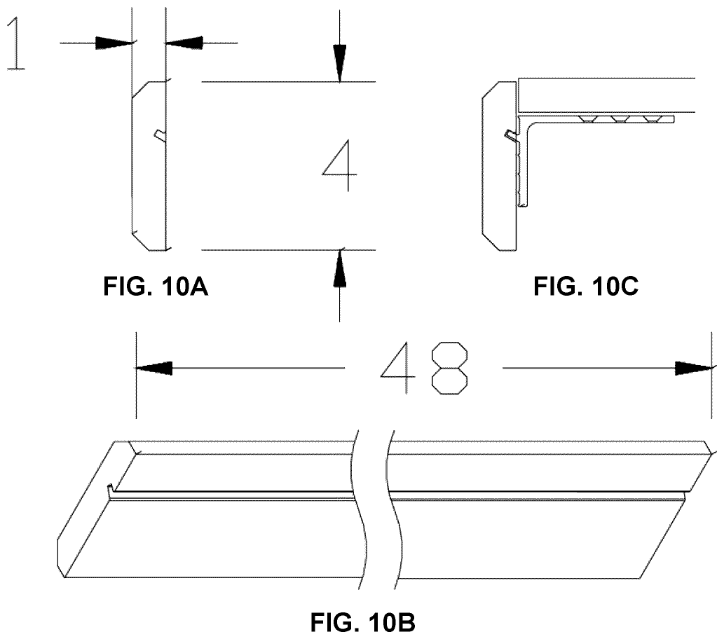

FIG. 10A is a side view of a coping tile cut with a saw system according to at least one embodiment described herein. FIG. 10B is a side view of the coping tile of FIG. 10A positioned on a coping bracket of a decking system. FIG. 10C is a rear perspective view of the coping tile of FIG. 10A.

While the above description provides examples of one or more apparatus, methods, or systems, it will be appreciated that other apparatus, methods, or systems may be within the scope of the claims as interpreted by one of skill in the art.

1. A clamp for securing a workpiece against an upper surface of a base for a saw to cut the workpiece while travelling in a direction parallel to a longitudinal axis of the clamp, the clamp comprising:
an elongate body having a top surface, a bottom surface, a first end and a second end, the elongate body being positioned above the workpiece and below a motor of the saw;
a first connector configured to secure the first end of the elongate body to the base at a first side of the base; and
a second connector configured to secure the second end of the elongate body to the base at a second side of the base;
wherein the first connector and the second connector provide for the clamp to move between a raised position where the elongate body is coupled to the base and disengaged from a top surface of the workpiece and a lowered position where the elongate body is coupled to the base and presses down on the top surface of the workpiece and secures the workpiece against the upper surface of the base when the workpiece is positioned between the first connector and the second connector.

2. The clamp of claim 1, wherein the elongate body maintains a position above the workpiece and below the motor of the saw as the clamp moves between the raised and lowered positions.

3. The clamp of claim 1, wherein the first connector and the second connector provide for the elongate body of the clamp to remain parallel with the top surface of the base as the clamp moves between the raised position and the lowered position.

4. The clamp of claim 3, wherein the first connector and the second connector each include a linkage member that is pivotally coupled to the base and pivotally coupled to the elongate body of the clamp.

5. The clamp of claim 1, wherein the first connector is a hinge positioned at the first end of the elongate body and the second connector includes an actuator positioned at the second end of the elongate body and is configured to extend upwardly from the base to move the clamp between the raised position and the lowered position.

6. The clamp of claim 1 further comprising two actuators, one actuator being positioned at each of the first end and the second end of the elongate body.

7. The clamp of claim 1 further comprising an actuator having a first end coupled to the elongate body and a second end coupled to the base, the actuator being configured to move the elongate body between the raised position and the lowered position.

8. The clamp of claim 1 further comprising a conformity mat covering at least a portion of the bottom surface of the elongate body.

9. The clamp of claim 1, wherein the workpiece has a first edge positioned adjacent to the first side of the base and a second edge adjacent to the second side of the base and the elongate body presses down on the top surface of the workpiece and secures the workpiece against the upper surface of the base from the first edge of the workpiece to the second edge of the workpiece.

10. The clamp of claim 1 further comprising a guide configured to direct motion of a carriage carrying a saw for the saw to cut a workpiece while travelling in a direction parallel to a longitudinal axis of the clamp.

11. The clamp of claim 10, wherein the guide is a rail forming the top surface of the elongate body, the rail being shaped to slidingly couple with the carriage to direct the motion of the carriage and the saw.

12. The clamp of claim 10, wherein the guide is a rail coupled to the elongate body, the rail being shaped to slidingly couple with the carriage to direct the motion of the carriage and the saw.

13. The clamp of claim 10, wherein the elongate body presses down across the top surface of the workpiece and secures the workpiece against the upper surface of the base from a first edge of the workpiece to a second edge of the workpiece.

14. A saw system for cutting a workpiece, the system comprising:
a base having an upper surface to support the workpiece thereon, the upper surface of the base being sloped relative to the ground;
the clamp claim 10; and
a carriage coupled to the clamp and configured to carry a saw along the guide of the clamp to cut the workpiece.

15. The saw system of claim 14, wherein the base includes:
a drainage mat;
a table having the drainage mat positioned on top of the table and the workpiece positioned on top of the drainage mat; and
a water trough positioned adjacent to the workpiece to collect water travelling on a top surface of the workpiece and/or within the drainage mat below the workpiece.

16. The saw system of claim 15, wherein the water trough is positioned adjacent to a lower end of the workpiece to collect water travelling on the top surface of the workpiece and/or within the drainage mat.

17. The saw system of claim 16, wherein the water trough includes one or more openings to receive water from the drainage mat.

18. The saw system of claim 14 further comprising a manual actuator configured to move the clamp between the raised and lowered positions and a powered actuator configured to drive the carriage carrying the saw from a home position to a stop position along the longitudinal axis of the clamp for the saw to cut the workpiece.

19. The saw system of claim 18, wherein the manual actuator is configured to provide for the carriage to disengage the powered actuator when the clamp is at the raised position and the carriage can be moved manually by a user to return the carriage to the home position.

20. The saw system of claim 19, wherein the powered actuator comprises a carriage-mounted drive motor with a drum and a wire having a variable length, and the clamp comprises a spring tensioner that disengages the carriage from the powered actuator when the clamp is at the raised position.

21. The saw system of claim 14 further comprising a cart for transporting the saw system, the cart having a tiltable frame that provides for the car to move between a working position and a travel position, the cart having a smaller width when in the travel position than when in the working position.

22. The saw system of claim 18 further comprising a controller, the controller being configured to:
receive a first signal confirming that the carriage is at a home position;
in response to receiving the first signal and receiving a user input, activate a water pump, a blade drive of the saw and the powered actuator of the carriage to initiate cutting the workpiece; and
receive a second signal confirming that the carriage is at a stop position; and
in response to receiving the second signal, deactivate the water pump, the blade drive of the saw and the powered actuator of the carriage.

23. A method of cutting a workpiece with a saw of a saw system, the method comprising:
positioning the workpiece on an upper surface of a base of the saw system between a first connector and a second connector of a clamp of the saw system, the upper surface of the base being sloped relative to the ground;
positioning the workpiece on the base so a desired cut line of the workpiece is aligned with a blade of the saw;
moving the clamp to a lowered position where an elongated body of the clamp presses down on the top surface of the workpiece and secures the workpiece against the upper surface of the base; and
while the clamp remains in the lowered position, directing a carriage carrying the saw in a direction parallel to a cut line and parallel to a longitudinal axis of the clamp to cut the workpiece along the cut line.
